(19) United States
(12) Patent Application Publication
(10) Pub. No.: US 2005/0133371 A1
(43) Pub. Date: Jun. 23, 2005

(54) Apparatus and method for Edman degradation on a microfluidic device utilizing an electroosmotic flow pump

(75) Inventor: Aaron T. Timperman, Morgantown, WV (US)

Correspondence Address: PALMER & DODGE, LLP;PAULA CAMPBELL EVANS, 111 HUNTINGTON AVENUE, BOSTON, MA, 02199, US

(73) Assignee: West Virginia University Research Corporation

(21) Appl. No.: 10/955,657

(22) Filed: Sep. 30, 2004

Related U.S. Application Data
(60) Provisional application No. 60/507,434, filed on Sep. 30, 2003.

(51) Int. Cl. G01N 27/453

(52) U.S. Cl. 204/450; 204/600

(57) ABSTRACT

The present invention comprises an electroosmotic flow pump with both anion and cation exchange beads packed in separate channels that pump towards an intersection. Combining the two flow streams results in higher flowrates for the pump and allows operation of the pump over a wide pH range. The pump can be used to deliver solutions ranging from a pH of about 2 to about 12. In a preferred embodiment, the electroosmotic pump of the present invention is fabricated on a microfluidic device capable of Edman degradation. In a preferred embodiment of the present invention, the beads are immobilized in the channels using weirs and membranes, eliminating the need for frits. The pump may be comprised of capillaries. Additionally, the electroosmotic flow pump of the present invention may be integrated into an Integrated Microfluidic Proteome Analysis System.

### RELATED APPLICATIONS

The current application claims priority to U.S. Provisional Application No. 60/507,434, filed on Sep. 30, 2003, the entirety of which is incorporated herein.

### FIELD OF THE INVENTION

The present invention relates to a microfluidic device, and, more particularly, to an apparatus and method for performing Edman degradation on a microfluidic device utilizing a electroosmotic flow pump.

### BACKGROUND OF THE INVENTION

Microfluidic devices hold much promise for the analysis of chemical and biological systems due to their ability to increase speed and sample analysis through massive parallelism, fast separations, the use of small volumes, and short diffusion lengths. Microfluidic systems have been developed for DNA analysis, high throughput screening, antigen detection, and point of care diagnostic medical devices.

Fluid control involving mass transport and direction through the channels is crucial to the development of functional devices. Mass transport is achieved using either hydrodynamic or electrokinetic pumping. Control of flow direction in hydrodynamically driven systems requires on-chip active or passive valves for switching flow streams whereas electrokinetic systems utilize electrokinetic valving. Micropumps can be classified as either field-induced flow pumps or mechanical membrane-displacement pumps. Field-induced pumps include electroosmotic flow (“EOF”), electrohydrodynamic, centrifugal, and magneto-hydrodynamic pumps; while mechanical membrane-displacement pumps include electrostatic, electromagnetic, thermo-pneumatic, photo-thermal, and piexoelectric pumps.

EOF pumps offer several advantages over membrane-displacement pumps. Fabrication of field induced flow pumps is relatively simple, requires no moving parts, and the pumps can be easily integrated into electrokinetically driven systems. The EOF pumps are easy to operate and produce pulse free flow, which is important for microfluidic and flow injection analysis systems requiring a small and constant supply of solution. Microfluidic EOF pumps are capable of generating flowrates from a few nL/min to hundreds of μL/min. However, EOF pumps generally have low stall pressures, and therefore are generally not used in high pressure systems. Also, electroosmotic pumping requires that the liquid is polarizable, and does not work well for fluids that are non-conductive, highly conductive, and those at extreme pHs such as some organic solvents and strong acids, since the current levels are either excessive or inadequate to support any significant EOF. In contrast, mechanical pumps are able to pump almost any fluid with a typical flow range of 1-100 μL/min.

The use of electroosmosis for pressurized pumping emerged almost 40 years ago. Most surfaces develop an electric double layer (“EDL”) when brought into contact with electrolyte solutions produced by the zeta potential at the liquid/solid interface. In the case of glass surface, deprotonation of acidic silanol groups produces a negatively charged surface. Counter ions from solution are attracted to the wall and shield these charges, with dissolved counter-ions being repelled from the wall forming the EDL. When an electric field is applied, the mobile ions in solution move in response to the field, dragging the bulk of solution with them, and thereby producing electroosmotic flow. Because electroosmotic flow pumps typically have low stall or maximum operating pressures, much research has focused on increasing the pump's ability to resist hydrodynamic flow in the reverse direction, which is produced by the backpressure. In hydrodynamically driven systems, the linear flow rate is directly proportional to the square of the channel radius as shown by:
V_{HD}=ΔPr²/8ηL
where ΔP is the backpressure, r is the capillary radius, V_{HD} is the hydrodynamic linear flowrate, η is the viscosity and L is the length of the capillary. In contrast, the linear flowrate developed by EOF is independent of the radius as shown by the following equation:
V_{EOF}=(ξε/4πη)E
where V_{EOF} is the electroosmotic linear flow rate, ξ is the zeta potential, ε is the dielectric constant, η is the viscosity and E is the electric field. The high surface area to volume ratio associated with this porous structure is also partially responsible for the generation of high pressures. Although smaller channels provide higher backpressures, the linear flow rate is constant and there is a reduction in the volumetric flow rate which is proportional to the reduction in cross-sectional area at constant linear flow rate. This reduction in the volumetric flow rate can be compensated for by fabricating a device with small channels in parallel. One method of producing many small parallel channels is to pack a large channel with small beads, such as chromatography beads. The interstitial spaces between the particles in a packed column form multiple parallel channels with very small radii. Such packed EOF pumps are capable of generating higher pressures (in excess of 20 atm) than EOF pumps made from open capillary columns.

Electroosmotic flow is strongly affected by a variation in pH, as the charge on the channel surface is influenced by pH. Therefore, the EOF velocity generated by most EOF pumps is greatly influenced by the solution pH. Most microfluidic EOF pumps are made from glass or fused silica. For glass and fused-silica devices, the surface charge or ξ potential is produced by deprotonation of silanol groups. A wide pH range is needed for optimizing separations, handling biological samples and for reactions that are pH sensitive.

A number of EOF pumps have been described by various researchers. Zeng et al. (Zeng et al, J. M. J. Sens. Actuators, B. 2002, 82, 209-212) recently designed and fabricated packed capillary column EOF pumps capable of generating flow rates of up to 3.6 μL/min for 2 kV applied potentials and pressures in excess of 20 atm. These EOF pumps were fabricated by packing 500-700 μm-i.d. fused-silica capillary columns with 3.5-μm non-porous silica particles and using a silicate frit fabrication process to hold the particles in place.

Others have developed an open-channel micropump with hundreds of parallel small-diameter open microchannels that can generate flow rates of 10-400 nL/min and pressures of up to 80 psi.

However, there is a need in the art for a device and method for incorporating an electroosmotic pump into a microfluidic device wherein the electroosmotic pump operates independent of pH. Additionally, there is a need in the art for an electroosmotic pump incorporated onto a microfluidic device wherein the electroosmotic flow pump may be utilized in reactions facilitated by a field free channel (such as Edman degradation). Additionally, there is a need in the art for an electroosmotic pump capable of operating with conductive or non-conductive fluids. In addition, there is a need in the art for such a simple electroosmotic flow pump design capable of an easy manufacturing process and avoiding several of the problems associated with installing a series of frits into a microfluidic device.

### SUMMARY OF THE INVENTION

The preferred embodiment of the present invention is an apparatus and method for Edman degradation on a microfluidic device utilizing an electroosmotic flow pump. The present invention comprises an electroosmotic pump with both anion and cation exchange beads packed in separate channels that pump towards an intersection. Combining the two flow streams results in higher flowrates for the pump and allows operation of the pump over a wide pH range. The EOF pump can be used to deliver solutions ranging from a pH of about 2 to about 12. In a preferred embodiment, the electroosmotic pump of the present invention is fabricated on a microfluidic device capable of Edman degradation. In a preferred embodiment of the present invention, the beads are immobilized in the channels using weirs and membranes, eliminating the need for frits. The preferred configuration makes the removal and replacement of fouled beads easy. Because no frits are used, there is no difficulty of frit fabrication, no contaminants such as polymer leachetes from frit fabrication, reduced outgassing, and reduced susceptibility to clogging. Additionally, the use of a highly porous membrane placed at an end of each pumping channel for retaining the beads in the pumping channels, decreases the resistance to flow through the channel and increases the maximum achievable flowrate of the pump. Therefore, these characteristics allow for easy fabrication and efficient operation of the electroosmotic pump of the present invention.

In one embodiment, the present invention provides an electroosmotic pump with both anion and cation exchange beads packed in separate channels that pump toward an intersection. Combining the flow streams results in higher flow rates for the pump over a wide pH range. This pump can be used to deliver solutions ranging from a pH of about 2 to a pH of about 12. The beads are immobilized in the channels using weirs and membranes, eliminating the need for frits. The configuration of the invention facilitates the removal and replacement of fouled beads. Since no frits are used, there is no difficulty of frit fabrication, no contaminates such as polymer leachates from frit fabrication, reduced outgassing, and reduced susceptibility to clogging. Therefore, these characteristics allow for easy fabrication and efficient operation of the EOF pump of the present invention.

A preferred embodiment of the present invention comprises an electroosmotic flow pump for use on a microfluidic device comprising a first channel having a plurality of anionic beads, a second channel comprising a plurality of cationic beads and an intersection point where the first channel engages the second channel. In a preferred embodiment, the first channel and the second channel each narrow in a diameter as each channel approaches the intersection point. Further, a field free channel engages the first channel and the second channel at the intersection point.

In one embodiment of the present invention, the electroosmotic pump comprises a first channel and a second channel wherein the channels are packed with beads. In one embodiment of the invention, the first channel is packed with anionic beads and the second channel is packed with cationic beads.

In a preferred embodiment of the present invention, the ends of the pumping channels near the intersection with the field free channel are designed to have an increased frictional resistance to flow. This increased frictional resistance can be achieved by reducing the cross-sectional area, altering the channel geometry or incorporation of a frit or a frit-like material or other such means. Although this feature decreases the maximum achievable flow rates at intermediate pHs, it increases the flowrate at both high and low pHs.

In a preferred embodiment of the present invention, the packed columns provide greater pressures through increasing the resistance of the channel to hydrodynamic back flow. In a preferred embodiment, columns are packed with beads about 0.5 μm in diameter to increase the resistance of the channels to hydrodynamic backflow.

In an alternative embodiment of the present invention, the EOF pump comprises a plurality of parallel channels with convergent flow streams wherein a similar result is achieved as compared to a channel packed with beads. The EOF pump comprises two sets of small channels with oppositely charged coating that would produce convergent flow streams. The small channels in each set would have a coating with the same surface charge (positive, neutral, or negative.) The sets of channels would have opposite surface charges, producing convergent flow streams. In one embodiment of the invention, the convergent flow streams eliminate the need for a frit. Using small parallel channels eliminates the need for beads but requires the coatings.

In a preferred embodiment of the present invention, a method of membrane sealing facilitates the replacement of fouled beads from either the first or second channel. In one embodiment, a membrane is simply compressed against the exterior of the device with using a threaded fitting. In one embodiment, the membrane is thin and has relatively large pores (because it only has to retain the 5 micron beads), and therefore produces minimal resistance to flow which increases the flow rate through the field free capillary.

In a preferred embodiment, the design of the EOF pump is fritless. In one embodiment, the EOF pump comprises an external or integrated frit.

In one embodiment of the present invention, each channel comprises a constriction before the intersection point wherein the constriction reduces hydrodynamic backflow through the non-pumping channels and increases hydrodynamic pumping flow rate out of the field free channel.

In one embodiment of the present invention, the convergent flow streams enable pumping of pure ionic liquids and ionic solutions such as acids, bases, other electrolytes, and pure trifluoroacetic acid (“TFA”), a reagent used in Edman degradation.

Further, the present invention comprises a method of utilizing an electroosmotic flow pump over a pH range comprising providing a first channel comprising a first set of beads, providing a second channel comprising a second set of beads, and engaging the first channel to the second channel at an intersection point wherein the first channel and the second channel narrow in diameter as each channel approaches the intersection point. Next, engaging the first channel and the second channel at the intersection point with a field free channel. The method of the present invention allows a reagent to be pumped electroosmotically through the field free channel. The method allows for pumping solutions previously incapable of being delivered through a microfluidic system by EOF due to wide pH ranges. The present invention solves this problem.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention.

FIG. 1A is a schematic view of an electroosmotic flow pump of the present invention.

FIG. 1B is a schematic view of a weir located within a channel of the electroosmotic flow pump of the present invention.

FIG. 2 is a view of an embodiment of the present invention showing a first channel packed with a plurality of cationic beads, a second channel packed with anionic beads and a hydrodynamic flow created in a field free channel which pumps a solution from the field free channel to a field free buffer reservoir.

FIG. 3 is a graph displaying a relationship between volumetric flow rate and applied voltage for the embodiment of the electroosmotic flow pump of the present invention as shown in FIG. 1A.

FIG. 4 is an alternative embodiment of the present invention wherein the electroosmotic pump of FIG. 2 is shown with a positive electrode and a negative electrode are revered resulting in a change in direction of a hydrodynamic flow in a field free channel.

FIG. 5 is an alternative embodiment of the present invention wherein a first channel comprises a set of cationic beads and a second channel contains no charge therefore operating as a block to a hydrodynamic flow and generating no electroosmotic flow. In addition, the flow can be reversed by switching a set of electrodes.

FIG. 6 is an alternative embodiment of the present invention wherein a second channel comprises a set of anionic beads and a first channel contains no charge therefore operating as a block to a hydrodynamic flow and generating no electroosmotic flow. In addition, the flow can be reversed by switching a set of electrodes.

FIG. 7 is a schematic view of a preferred embodiment of the electroosmotic flow pump wherein a first channel and a second channel narrow in diameter prior to reaching an intersection point to facilitate a hydrodynamic flow through a field free channel at pH extremes when the flow produced by one of the pumping arms is greatly minimized.

FIG. 8A is a graph displaying a relationship between pH and volumetric flow rates at an applied voltage of 3 kV for the preferred embodiment of the electroosmotic flow pump of the present invention wherein the columns are packed with anion and cation beads respectively of about 0.5 μm in diameter.

FIG. 8B shows a relationship between pH and volumetric flow rates at an applied voltage of 3 kV, for a microfluidic electroosmotic flow pump utilizing kasil frit to confine a plurality of beads to their respective channels.

FIG. 9 is an alternative embodiment of the present invention wherein an electroosmotic pump of the present invention comprises system of capillaries.

FIG. 10 is a graph displaying a relationship between volumetric flow and applied voltage for an alternative embodiment of the present invention represented in FIG. 9.

FIG. 11 is a schematic view of a microfluidic system of the present invention.

FIG. 12 is a schematic view of an integrated proteomic microfluidic analysis module including a microfluidic device for Edman degradation of the present invention.

FIG. 13 is a box diagram showing the microfluidic device of the present invention.

FIG. 14 is a view of an embodiment of the microfluidic device of the present invention wherein a substantially purified polypeptide and a cleaved amino acid are concentrated in front of an ultrafiltration membrane.

FIG. 15 is a view of the embodiment as shown in FIG. 14 further comprising an electroosmotic flow pump.

FIG. 16 is a view of the embodiment as shown in FIG. 15 further comprising a plurality of hydrodynamic flow restrictors to prevent contamination of a reagent pumped into the field free channel.

FIG. 17 is a view of the present invention comprising a plurality of ultrafiltration membranes.

FIG. 18 shows an alternative embodiment of the present invention wherein a first channel, a second channel and a field free channel are in a “Y” configuration.

FIG. 19 shows an alternative embodiment of the present invention wherein a first channel and a second channel are curved.

While the above-identified drawings set forth preferred embodiments of the present invention, other embodiments of the present invention are also contemplated, as noted in the discussion. This disclosure presents illustrative embodiments of the present invention by way of representation and not limitation. Numerous other modifications and embodiments can be devised by those skilled in the art which fall within the scope and sprit of the principles of the present invention.

### DETAILED DESCRIPTION

The preferred embodiment of the present invention is an apparatus and method for Edman degradation on a microfluidic device utilizing an electroosmotic flow pump. The present invention comprises an electroosmotic pump with both anion and cation exchange beads packed in separate channels that pump towards an intersection. In a preferred embodiment of the present invention, the electroosmotic pump is used to pump reagents necessary in a step of Edman degradation. In an alternative embodiment, the electroosmotic pump is used to pump any reagent. In a preferred embodiment of the present invention, combining a first flow stream and a second flow stream results in a higher flow rate for the electroosmotic flow pump. Additionally, the preferred embodiment allows for the pump to operate over a wide pH range. In a preferred embodiment, the pH of a reagent to be pumped is from about 2 to about 12.

In a preferred embodiment of the present invention, a plurality of cationic beads are confined to a first channel and a plurality of anionic beads are confined to a second channel by a weir. In an alternative embodiment, a membrane is used to confine the beads to their respective channels. Such a configuration eliminates the need for a frit. As such, the present invention facilitates the process of removing and replacing fouled beads. In addition, because no frits are used, there is no difficulty of frit fabrication, no contaminants such as polymer leachates from frit fabrication, reduced outgassing, and reduced susceptibility to clogging. As such, the present invention allows for easy fabrication and efficient operation of an electroosmotic pump.

### Definitions

The following definitions are provided for specific terms which are used in the following written description and claims.

As used herein, a “substantially purified polypeptide” refers to a polypeptide sample which comprises polypeptides of substantially the same molecular mass (e.g., greater than about 90%, preferably greater than about 95%, greater than about 98%, and up to about 100% of the polypeptides in the sample are of substantially the same molecular mass). Substantially purified polypeptides do not necessarily comprise identical polypeptide sequences. A substantially purified polypeptide may range from 1 protein to many thousands of proteins.

As used herein, a “cleavage reaction” refers to a reaction within a reaction channel of the microfluidic device of the present invention in which a terminal amino acid is cleaved from an end of a peptide or polypeptide confined in the reaction channel. The cleavage reaction produces “a cleavage product”.

As used herein, a “cleavage product” refers to the product of the cleavage reaction. The cleavage product comprises a terminal amino acid or a small peptide cleaved from a peptide or polypeptide wherein the peptide or polypeptide is confined to the reaction channel.

As used herein, “a sample band” or “sample plug” refers to a volume of a fluid which comprises a sample (e.g., a substantially purified polypeptide or substantially purified peptide).

As used herein “a sample” refers to polypeptides and/or peptides. A sample can be obtained from a variety of sources including, but not limited to: a biological fluid, suspension, buffer, collection of cells, scraping, fragment or slice of tissue, a tumor, an organism (e.g., a microorganism such as a bacteria or yeast). A sample also can comprise a subcellular fraction, e.g., comprising organelles such as nuclei or mitochondria.

As defined herein, a “configuration of parallel channels” is one which provides a common voltage output at an intersection point between the channels. However, the geometric arrangement of the channels is not necessarily parallel. However, they should be configured as a set of parallel resistors in a circuit having a common input channel and a common output channel.

As used herein, “a system processor” refers to a apparatus comprising a memory, a central processing unit capable of running multiple programs simultaneously, and preferably, a network connection terminal capable of sending and receiving electrical signals from at least one non-system apparatus to the terminal. The system processor is in communication with one or more system components (e.g., modules, detectors, computer workstations and the like) which in turn may have their own processors or microprocessors. These latter types of processors/microprocessors generally comprise memory and stored programs which are dedicated to a particular function (e.g., detection of fluorescent signals in the case of a detector processor, or obtaining ionization spectra in the case of a peptide analysis module processor, or controlling voltage and current settings of selected channels on a device in the case of a power supply connected to one or more devices) and are generally not directly connectable to the network. In contrast, the system processor integrates the function of processors/microprocessors associated with various system components to perform proteome analysis as described further below.

As used herein, a “database” is a collection of information or facts organized according to a data model which determines whether the data is ordered using linked files, hierarchically, according to relational tables, or according to some other model determined by the system operator. Data in the database are stored in a format consistent with an interpretation based on definitions established by the system operator.

As used herein, “a system operator” is an individual who controls access to the database.

As used herein, an “information management system” refers to a program, or series of programs, which can search a database and determine relationships between data identified as a result of such a search.

As used herein, an “interface on the display of a user apparatus” or “user interface” or “graphical user interface” is a display (comprising text and/or graphical information) displayed by the screen or monitor of a user apparatus connectable to the network which enables a user to interact with the database and information management system according to the invention.

As used herein, a “peptide” refers to a biomolecule comprising fewer than 20 consecutive amino acids.

As used herein, a “polypeptide” refers to a biomolecule which comprises more than 20 consecutive amino acids. The term “polypeptide” is meant to encompass proteins, but also encompasses fragments of proteins, or cleaved forms of proteins or partially digested proteins which are greater than 20 consecutive amino acids.

### Electroosmotic Flow (“EOF”) Pump

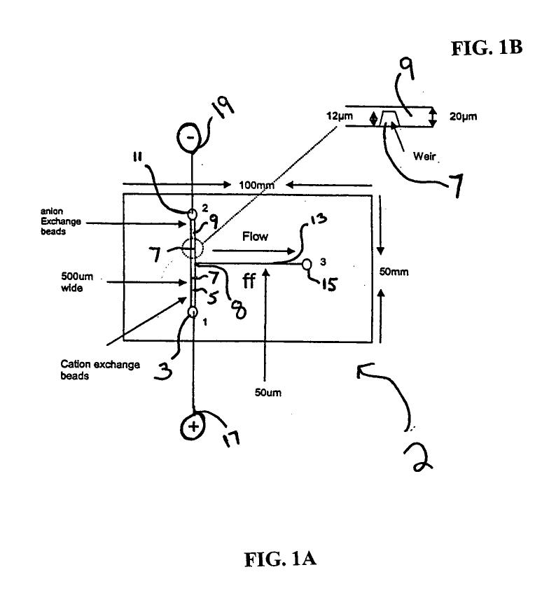

FIG. 1A shows a schematic representation of a preferred embodiment of an electroosmotic pump integrated into a microfluidic chip 2 of the present invention. The embodiment comprises a first channel 5 engaging a second channel 9 at an intersection point 8. In an embodiment of the present invention, the first channel 5 is approximately linear to the second channel 9.

In an embodiment, the first channel 5 is engaged to a first buffer reservoir 3. Additionally, the second channel 9 is engaged to a second buffer reservoir 11. Solutions and reagents to be pumped may be added via the first buffer reservoir 3 and/or the second reservoir 11.

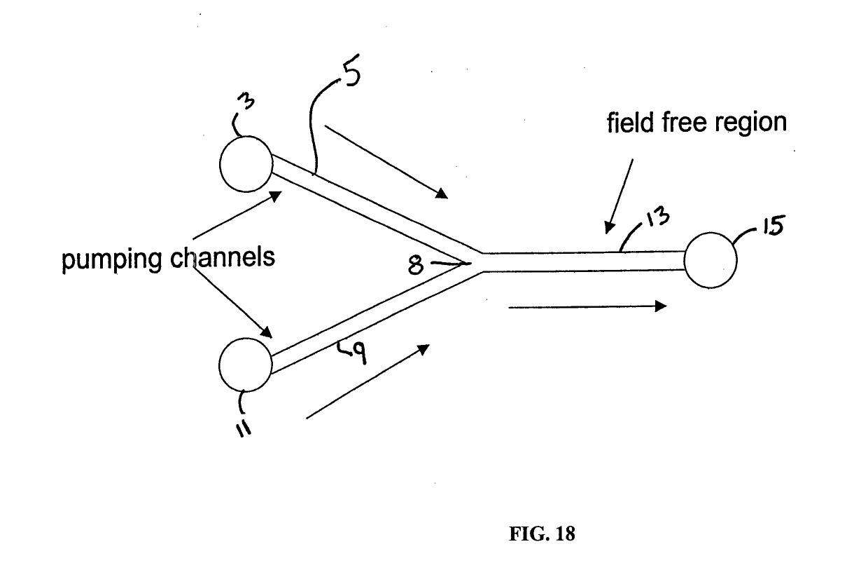

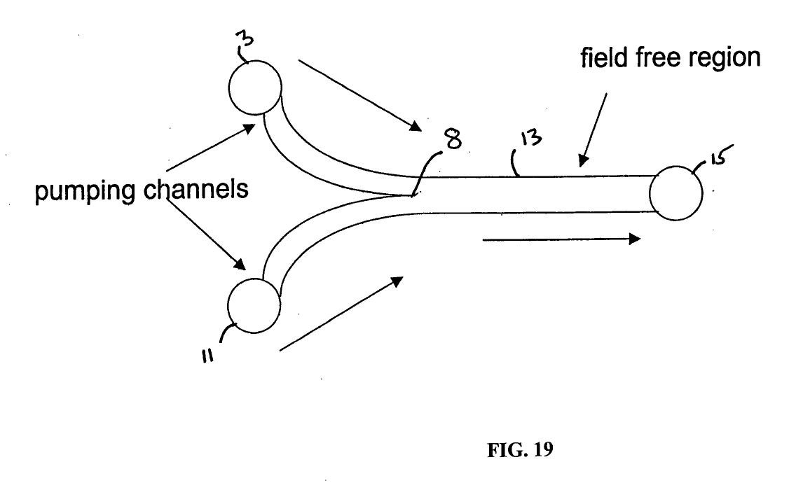

In an embodiment of the present invention, a field free channel 13 engages the first channel 5 and the second channel 9 at the intersection point 8. The field free channel 13 of the present invention comprises no electric charge. In an embodiment of the present invention, the field free channel 13 is approximately perpendicular to the first channel 5 and the second channel 9. In an alternative embodiment (as shown in FIG. 18), the first channel 5, the second channel 9 and the field free channel 13 may form a “Y-configuration”. In another embodiment (as shown in FIG. 19), any or all of the first channel 5, the second channel 9 and/or the field free channel 13 may be curved or bent. It should be obvious to those skilled in the art that many geometric configurations may be within the spirit and scope of the present invention.

In an embodiment of the present invention, the first channel 5 is approximately 500 μm in width. The second channel 9 is approximately 500 μm in width. In an embodiment of the present invention, the field free channel 13 is approximately 50 μm in width. Those skilled in the art will recognize that a width of the first 5 or second channel 9 greater than or less than 500 μm or a width of the field free channel 13 greater than or less than 50 μm is within the spirit and scope of the invention. The first 5 and second channels 9 are wider than the field free channel 13 in order to increase the flow rate through the field free channel 13. The width of the first 5 and second channels 9 can be increased in order to obtain higher flow rates or decreased if lower flowrates are required.

In an embodiment of the present invention, the first channel 5 and the second channel 9 are each approximately 20 μm and approximately 3.8 cm in length. Those skilled in the art will recognize that variations in the depth and/or length of the first channel 5 and the second channel 9 are within the spirit and scope of the present invention. In an embodiment of the present invention, a weir 7 located within the first channel 5 is placed about 6.5 mm from the intersection point 8. Additionally, a weir 7 of the second channel 9 is placed about 6.5 mm from the intersection point 8. Those skilled in the art will recognize that the weir 7 may be placed at various locations within the first channel 5 and/or the second channel 9 and be within the spirit and scope of the present invention.

In an embodiment of the present invention, the field free channel 13 is about 5 cm in length and about 20 μm in depth. Those skilled in the art will recognize that an increase or decrease in the length or depth of the field free channel 13 is within the spirit and scope of the present invention.

In an embodiment of the present invention, a positive electrode 17 and a negative electrode 19 (the electrodes 17, 19 are positive and negative with respect to each other; not with respect to the ground) are utilized to determine the direction of flow within the various channels. In the embodiment of FIG. 1A, the positive electrode 17 is positioned proximate to the first channel 5 and the negative electrode 19 is positioned proximate to the second channel 9.

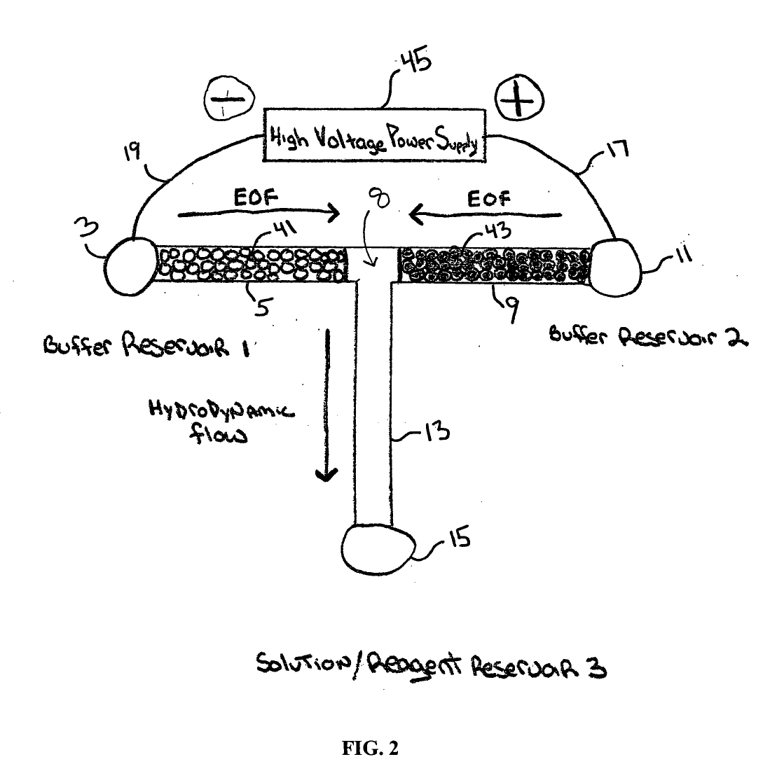

FIG. 1B shows a segment of the second channel 9 as shown in FIG. 1A wherein the second channel 9 comprises the weir 7. In an embodiment, a plurality of beads (to be discussed in conjunction with FIG. 2) are immobilized in each the first channel 5 and the second channel 9 by a weir 7 positioned in the first channel 5 prior to the intersection point 8 and by a weir 7 positioned in the second channel 9 prior to the intersection point 8. Additionally, a membrane (not shown) may be used to prevent the plurality of beads from exiting the first channel 5 via the first buffer reservoir 3 and used to prevent the plurality of beads from exiting the second channel 9 via the second buffer reservoir 11. The present invention eliminates the requirement for frits. As such, the configuration of the present invention facilitates removal and replacement of fouled beads. Additionally, because no frits are used, the present invention eliminates the difficulty of frit fabrication, eliminates contaminates such as polymer leachants which result from frit fabrication, reduces outgassing and reduces the system's susceptibility to clogging.

As shown in FIG. 1B, the weir 7 of an embodiment of the present invention is about 12 μm in height. Additionally, a distance from a cover glass to a bottom of a channel 5,9 is approximately 20 μm in height. As such, an embodiment of the present invention comprises a distance of approximately 8 μm in height from the top of the weir 7 to the cover glass. Those skilled in the art will recognize that a weir 7 higher than or lower than 12 μm in height, a channel height higher than or lower than 20 μm in height, or a height from the top of the weir 7 to a cover glass higher than or lower than 8 μm in height are all within the spirit and scope of the present invention.

The plurality of weirs 7 were fabricated in a single step process by incorporating about a 50 μm gap into a channel mask and carefully controlling a series of etching conditions and time. An etching time of about 25 minutes was found to reproducibly yield about a 20 μm deep channel with an 8 μm gap between a highest point on the weir 7 and a cover glass (not shown). Longer etching times produced deeper channel and a larger gap between the weir 7 and the cover glass.

In constructing the EOF pump of the present invention, the channels were patterned on a glass chip using standard photolithography and wet chemical etching methods on Borosilicate D263 glass. The photomasks were designed using Freehand 10 program, and the negatives were printed on Afga Accuset 100 printer with a resolution of 3000 dpi. The weirs on the microchip were made by including a 50 μm gap in the mask of the channel at weir locations and controlling the glass etching time. The glass substrates were etched 50% HF/70% HNO_{S}/H₂O, 2/1/7, v/v/v at an approximate etching rate of 0.8 μm/min for 25 minutes. Holes were drilled in the glass using a precision drill press (Tralmike's-Tool-A-Rama, Plainfield, N.J.) After fabrication, the glass plates were cleaned with acetone and with a soap solution. The plates were placed in a 1:1:1 solution of NH₄OH/H₂O₂/H₂O solution at 80° C., rinsed with deionized water and finally in Piranha (NH₄OH/H₂O₂, 3:1 v/v) solution at about 100° C., after which the glass plates were washed in a high pressure wafer washer for 5 washing and drying cycles using deionized water. A microscope (Leica GZ6 stereo-microscope) was used to aid with the alignment of the two glass chips. Permanent bonding was achieved by placing the glass plates in the furnance and applying the temperature program; 25-100° C. at 400° C./min, 100° C. for 15 min, 100° C.-600° C. at 10° C./min, 600° C. for 15 minutes. The furnance was allowed to cool naturally to ambient temperature.

After bonding, the microfluidic device 2 was rinsed first with 0.1M sodium hydroxide for 5 minutes, followed by 25 mM phosphate buffer at pH 6.8. The same buffer was used to measure the resistance of each channel and obtain an Ohm plot. The current was determined indirectly by measuring the voltage drop across a 10 kΩ resistor using a Fluke 75 Multimeter. The channel dimensions were measured using a stylus instrument (Tencor Instruments). The beads (to be discussed below) were suspended in an acetonitrile slurry and packed by placing the cation exchange bead slurry in a first buffer reservoir, the anion exchange beads in a second buffer reservoir and applying vacuum at a third buffer reservoir. Changing to the aqueous buffer after packing caused the beads to agglomerate and become stable in the channel. Threaded, flat bottom, PEEK polymer nanoport reservoir (Upchurch Scientific, N-131) with nuts were attached to the top plate. A 3 mm diameter teflon filter membrane (Applied Biosystems) was sealed against the cover plate with the nut and an O-ring.

In a preferred embodiment of the present invention, a first membrane was inserted in the first channel 5 directly adjacent to the first buffer reservoir 3 thereby preventing a plurality of beads (to be discussed below) from migrating into the first buffer reservoir 3. Additionally, a second membrane is inserted in the second channel 9 directly adjacent to the second buffer reservoir 11. Those skilled in the art will recognize that the first membrane and the second membrane may be placed at various locations in the respective first channel 5 and second channel 9.

In a preferred embodiment, the membrane of the present invention is teflon; large pores in the membrane allow for increased flow rate. Those skilled in the art will recognize that the membrane may be comprised of various materials. The membrane is held over the inlet of the first channel 5 or second channel 9 with a threaded fitting typically used for fluid transfer with small tubes in capillaries and liquid chromatography that compressed an O-ring against the Teflon filter and a top of the glass substrate. The design of the present invention facilitates filling with solution and the membrane did not cause buffer outgassing. The use of the membrane reduces clogging and provides an efficient method of sealing the beads of the device. Additionally, the present invention allows for an easy and efficient method for the removal of fouled beads. The method of bead entrapment of the present invention also eliminates any impurities associated with frit fabrication processes that increase the chemical background.

FIG. 2 shows an embodiment of the present invention wherein an electroosmotic flow is generated in the first channel 5 towards an intersection point 8 and an electroosmotic flow is generated in the second channel 9 towards the intersection point 8. Such flow in the first channel 5 and the second channel 9 creates a hydrodynamic flow down the field free channel 13. As shown in FIG. 2, the first channel 5 is packed with a plurality of beads 41. In an embodiment, the plurality of beads are cationic beads 41. In an embodiment, the second channel 9 is also packed with a plurality of beads 43. In an embodiment, the beads 43 of the second channel 9 are anionic beads 43. As shown in FIG. 2, a negative electrode 19 is engaged to the first channel 5 and a positive electrode 17 is engaged to the second channel 9. Once a high power voltage supply 45 is activated, a solution is pumped from the first buffer reservoir 3 and from the second buffer reservoir 11 into their respective channels 5,9.

A high voltage octochannel power supply (EMCO) connected to platinum wire electrodes was used to apply all electrophoretic voltages. Voltages were controlled using a program written with Lab Windows, a C programming environment, (National instruments, Austin, Tex.).

In an embodiment of the present invention, the effect of a plurality of parallel channels are produced by packing the first channel 5 with a plurality of cationic beads 41 and packing the second channel 9 with a plurality of anionic beads 43. The interstitial spaces between the beads 41,43 in the packed channels 5,9 form multiple channels with very small radii. Such packed electroosmotic flow pumps of the present invention are capable of generating higher pressures (in excess of 20 atm) than electroosmotic pumps made from an open capillary channel.

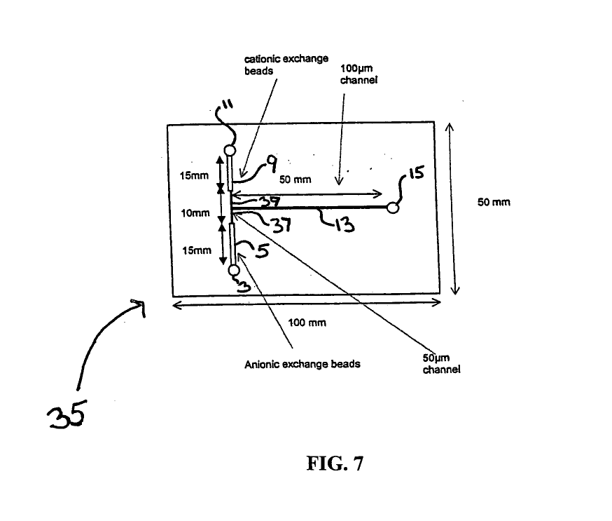

As shown in FIG. 2, the first channel 5 of the present invention comprises a plurality of cationic beads 41 and the second channel 9 comprises a plurality of anionic beads 43. In one embodiment, the cation beads 41 are poly(aspartic acid) beads (5 μm, 100 Å). In another embodiment, the cation beads 41 are poly(sulphonic acid) beads. In one embodiment, the anion beads 43 are polyethyleneimine beads (5 μm, 100 Å). The cationic beads 41 and the anionic beads 43 commercially available from Western Analytical Products, Inc (Murrieta, Calif. In a preferred embodiment, the beads, 41,43 would be less than 5 μm in diameter. Smaller beads would lead to smaller and a larger number of interstitial channels in the first channel 5 and the second channel 9. Such increased number of interstitial channels with a decreased diameter would lead to increased performance. In a preferred embodiment (to be discussed in conjunction with FIG. 7), the diameter of the beads are about 0.5 μm. In another embodiment, the columns may be packed with beads of various diameters. Those skilled in the art will recognize that the cation beads 41 and the anion beads 43 can range in diameter and still be within the spirit and scope of the present invention.

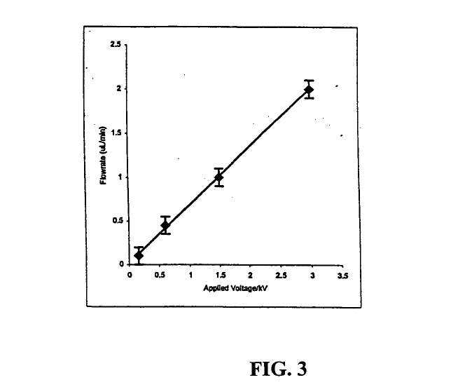

As shown in FIG. 2, an electroosmotic flow is generated in the first channel 5 towards the intersection point 8 and a similar flow is generated in the second channel towards the intersection point 8. Such a design creates a hydrodynamic flow from the intersection 8, through the field free channel 13, and towards a field free buffer reservoir 15. In an embodiment of the present invention, a maximum flow rate of a solution through the field free channel 13 of the electroosmotic pump is about 2 μL/min. The maximum flow rate was produced at an applied voltage of 3 kV using a 50 mM phosphate buffer at pH 6.8. FIG. 3 shows the relationship between the volumetric flow rate and an applied voltage for the preferred embodiment of the present invention as shown in FIG. 1 and FIG. 2.

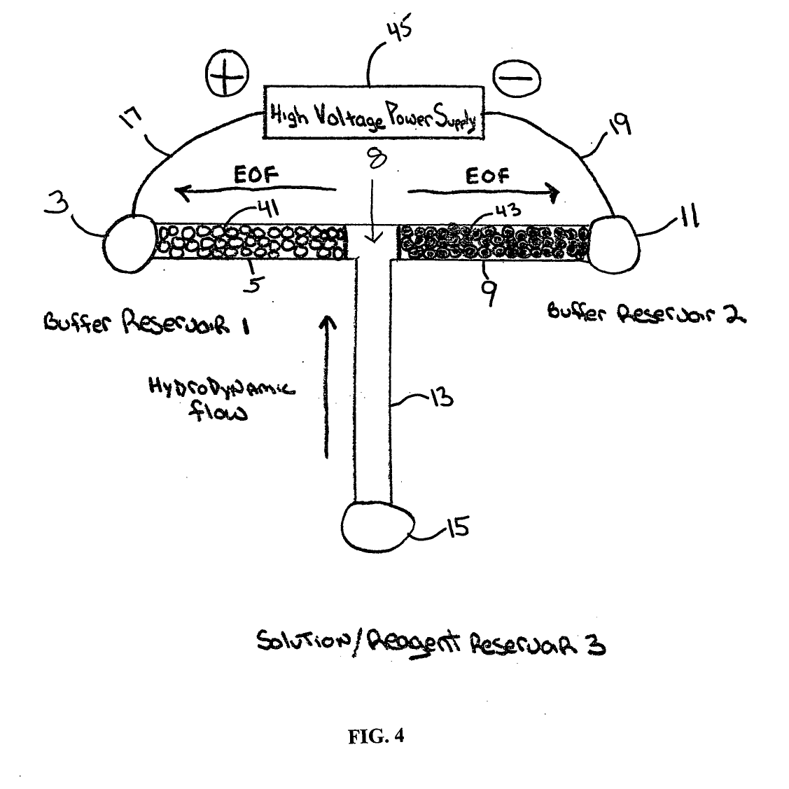

FIG. 4 shows an alternative embodiment of the present invention wherein a solution is pumped from the field free buffer reservoir 15 and into the field free channel 13. This embodiment of the invention is essentially the same embodiment as shown in FIG. 2 except that the positive electrode 17 is now engaged to the first channel 5 and the negative electrode 19 is now engaged to the second channel 9. Reversing the electrodes results in an electroosmotic flow to be generated in the first channel from the intersection point 8 towards the first buffer reservoir 3 and an electroosmotic flow is generated in the second channel 9 running from the intersection point 8 to the second buffer reservoir 11. As such, this embodiment allows a solution to be pumped into the field free channel 13 from the field free buffer reservoir 15.

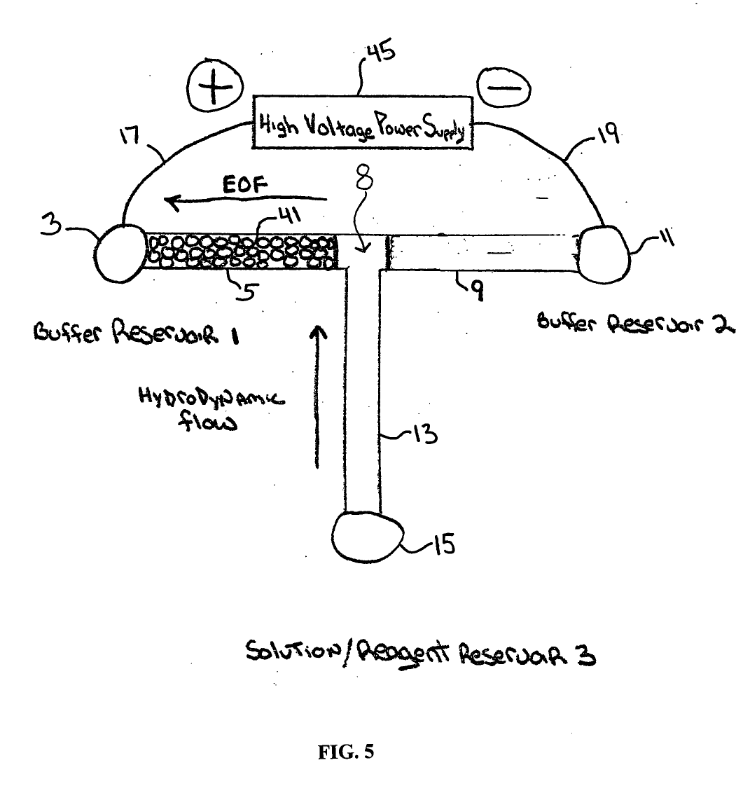

FIG. 5 shows an alternative embodiment of the present invention wherein the second channel 9 has little or no charge. As such, the second channel 9 of this embodiment operates as a block to the hydrodynamic flow and generates no electroosmotic flow through the second channel 9 because the second channel 9 has little or no charged surface. In this embodiment, an electroosmotic flow is generated in the first channel 5 and a hydrodynamic flow is generated in the field free channel 13. As shown in FIG. 5, a positive electrode 17 is engaged to the first channel 5 and a negative electrode 19 is engaged to the second channel 19. As such, a reagent may be pumped from the field free buffer reservoir 15 in the field free channel 13. In an alternative embodiment, flow can be reversed by reversing the positions of the positive electrode 17 and the negative electrode 19.

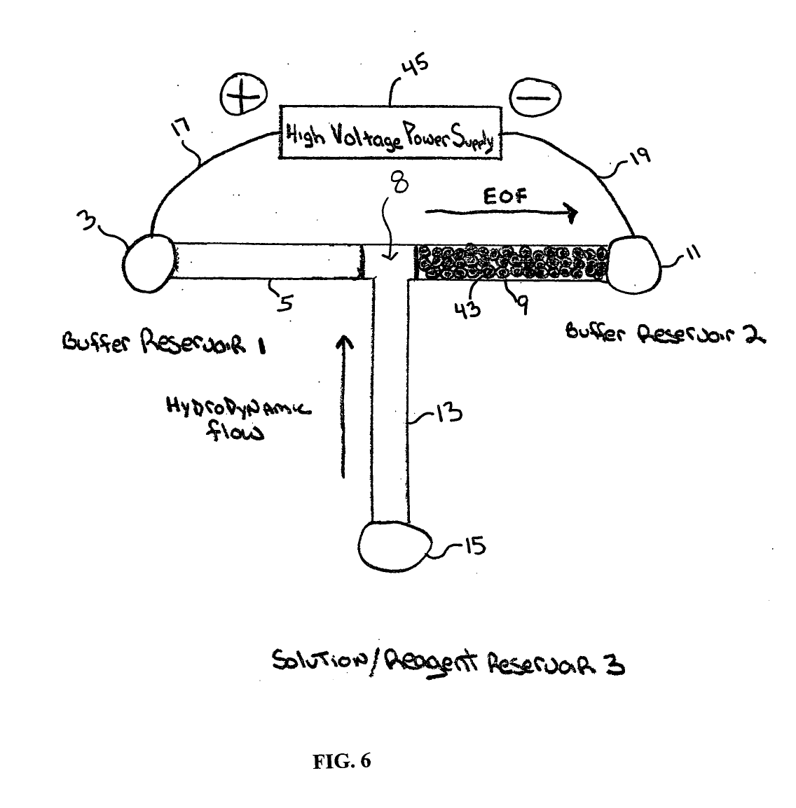

FIG. 6 shows an alternative embodiment of the present invention similar to the embodiment of FIG. 5, except that, the first channel 5 comprises little or no charge. As such, the first channel 5 of this embodiment operates as a block to the hydrodynamic flow and generates no electroosmotic flow through the first channel 5 because the first channel 5 has little or no charged surface. In this embodiment, an electroosmotic flow is generated in the second channel 9 and a hydrodynamic flow is generated in the field free channel 13. As shown in FIG. 6, a positive electrode 17 is engaged to the first channel 5 and a negative electrode 19 is engaged to the second channel 19. As such, a reagent may be pumped from the field free buffer reservoir 15 in the field free channel 13. In an alternative embodiment, flow can be reversed by reversing the positions of the positive electrode 17 and the negative electrode 19.

FIG. 7 shows a preferred embodiment of the present invention wherein the electroosmotic pump is designed to maximize the pH range at which the pump may operate. An important characteristic of the electroosmotic pump of the present invention is its ability to operate over an extended pH range. Most electroosmotic pumps are limited in the pH range in which they can operate because the zeta potential is dependent on the pH. For past microfluidic devices made in glass substrates, electroosmotic flow is produced by the deprotonation of acidic surface silanol groups. Therefore, the electroosmotic flow in glass devices is nearly zero below a pH of about 4 and reaches a maximum above a pH of 8 where all of the ionizable silanol groups are deprotonated.

In the present invention, the pH dependence is reduced by the use of two pumping channels, the first channel 5 and the second channel 9, with oppositely charged surfaces. The channel comprising the cation beads 41 produces most of the flow at high pH because the poly(aspartic acid) functional groups are largely deprotonated providing a negatively charged surface at pHs above its pKₐ. The channel comprising the anion beads 43 produces flow at low pH because polyethyleneimine functional groups are mostly positively charged at pHs below their pK_{b} of 9.1. Thus, the opposite surface charges insure that one of the channels is pumping at high or low pH.

The embodiment of the present invention as shown in FIG. 1A and FIG. 2 provides the highest maximum flow rate. The pH range of this design was limited because at low pH the channel comprising the cation beads 41 did not pump, and most of the flow from the anion beads 43 would flow through the channel comprising the cation exchange beads 41, bypassing the field free channel 13. At high pH, the situation was reversed and the solution pumped from the channel comprising the cation beads 41 would bypass the field free channel 13 and enter the channel comprising the anion beads 43.

To increase the useful pH range, the preferred embodiment of the present invention as shown in FIG. 7 was employed that restricts the flow between the first channel 5 and the second channel 9 by narrowing a width of the first channel 5 and a width of the second channel 9 immediately before each channel reaches the intersection point 8. The narrowed section of the first channel 5 and the second channel 9 provide a much greater resistance to hydrodynamic flow back through the non-pumping channel, and the design forces the majority of the solution through the field free channel 13.

As shown in FIG. 7, a first channel 5 engages the first buffer reservoir 3 at one end and leads into a first narrow channel 37 which immediately proceeds the intersection point 8. Additionally, a second channel 9 engages a second buffer reservoir 11 at one end and leads into a second narrow channel 39. The first narrow channel 37 and the second narrow channel 39 are hydrodynamic flow resistors. In another embodiment, a frit may be used as a hydrodynamic flow resistor as opposed to or in conjunction with including the first narrow channel 37 and the second narrow channel 39. In one embodiment, the first channel 5 is approximately 100 μm in width and the first narrow channel 37 is approximately 50 μm in width. In one embodiment, the first channel is about 15 mm in length. Additionally, the narrow channel 37 is approximately 5 mm in length. In one embodiment, the second channel 9 is approximately 100 μm in width and the second narrow channel 39 is approximately 50 μm in width. In one embodiment, the second channel 9 is about 15 mm in length. Additionally, the second narrow channel 39 is approximately 5 mm in length. Those skilled in the art will recognize that the length and width of the first channel 5, the first narrow channel 37, the second channel 9, and the second narrow channel 39 may vary and remain within the spirit and scope of the present invention. Those skilled in the art will recognize that either the first narrow channel 37 or the second narrow channel 39 could be omitted to improve the flowrate for either high or low pH solutions. If the first channel 5 contains the cation exchange beads 41, elimination of the first narrow channel 37 would increase the flow rate out of the first channel 5, but would also decrease the flowrate at low pH. If a pump was desired at high to moderate pHs this design would work well and provide increased flow rates.

In another embodiment of the present invention, an active valve may be placed in the first narrow channel 37 and/or the second narrow channel 39. In another embodiment, the first channel 5 and/or the second channel 9 may comprise the active valve. In one embodiment of the present invention, the active valve is a hydrogel valve. In another embodiment, the hydrogel valve is pH sensitive. Such valve would allow for better control over the flow rates of the respective pumping channels. In addition, the valves could be mechanical or electrical. As such, opening and closing the valve would serve as a hydrodynamic flow resistor. Those skilled in the art will recognize that various valves are within the spirit and scope of the present invention.

In an effort to further increase the resistance to hydrodymanic backflow, in a preferred embodiment the first column 5 and the second column 9 were packed with anion and cation beads respectively of about 0.51 μm in diameter. In an alternative embodiment, the columns 5,9 were packed with beads of various diameters, the diameters ranging from about 5 μm to 0.5 μm. As such, those skilled in the art will recognize that packing the columns with several beads of a constant diameter or packing the columns with beads of various diameters are within the spirit and scope of the present invention.

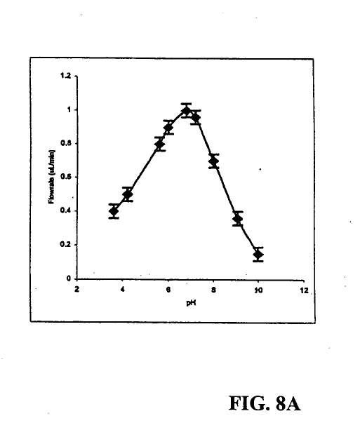

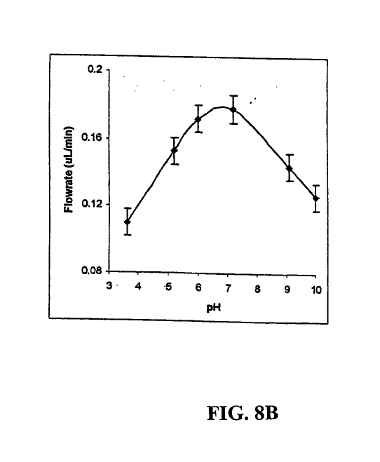

FIG. 8A shows a relationship between pH and volumetric flow rate through a field free channel 13 of the electroosmotic pump depicted in FIG. 7 at an applied voltage of 3 kV. As shown in FIG. 8A, the electroosmotic pump produced flow rates ranging from about 0.1 μL/min to about 1.0 μL/min over a pH range from about 3.3 to about a pH of 10.0 with a maximum flow rate of about 1.0 μL/min obtained at a pH of about 6.8. The maximum flow rate is less that the flow rate of about 2 μL/min obtained with the electroosmotic pump displayed in FIG. 1A and FIG. 2 at a pH of 6.8. The reduced maximum flow rate is caused by the narrowing of the first channel 5 and the second channel 9 prior to reaching the intersection point 8. With the use of the first narrow channel 37 and the second narrow channel 39 to reduce the backflow through the non-pumping channel, a trade-off is observed between the width of the pH range and the flow rate. The electroosmotic pump of the present invention can potentially produce flow at extreme pH values (below 3.3 and above 10) since the graph in FIG. 8A can be extrapolated to give flow rates at such pH values. A limitation in operating at extreme pH values can allow for the widening of the pH range in which the electroosmotic pump can operate. The useful pH range could be further extended by using acidic functional groups with a lower pKₐ and basic functional groups with a higher pK_{b}.

FIG. 8B shows a relationship between pH and volumetric flow rates at an applied voltage of 3 kV, for a microfluidic electroosmotic flow pump utilizing kasil frit to confine a plurality of beads to their respective channels. By comparing the results of FIG. 8B with the results of FIG. 8A, the flow rates at various pH values achieved by the electroosmotic pump utilizing frits were inferior to the flow rates achieved by the fritless electroosmotic pump which made use of a teflon membrane to confine the beads 41, 43 to their respective channel 5, 9. A maximum flow rate of slightly less than 0.2 μL/min was achieved for this design, as compared to the 1 μL/min for the fritless pump at pH 6.8. The kasil fritted electroosmotic flow pump also suffered from considerable outgassing and clogging problems. The fritless electroosmotic flow pump is therefore a more favorable configuration to use when fabricating the pump because of its superior performance.

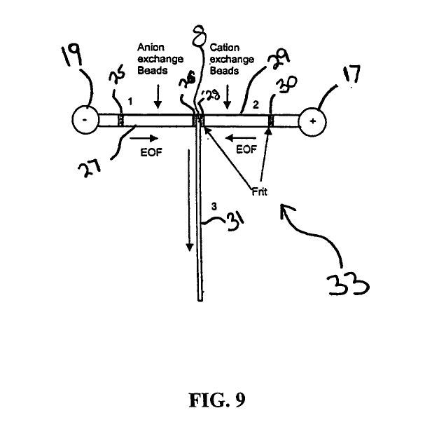

FIG. 9 shows an alternative embodiment of the present invention wherein the electroosmotic flow pump is constructed from a plurality of capillaries. As shown in FIG. 9, the electroosmotic flow pump of this embodiment comprises a first capillary 27 engaging a second capillary 29 at an intersection point 8. Additionally, a field free capillary 31 engages the first capillary 27 and engages the second capillary 29 at the intersection point 8. In one embodiment of the present invention, the first capillary 27 and the second capillary 29 are approximately linear. In another embodiment, the field free capillary 31 is approximately perpendicular to the first capillary 27 and the second capillary 29. In one embodiment, a first frit 25 and a second frit 26 confine a plurality of anion beads 43 to the first capillary 27. Additionally, a third frit 28 and a fourth frit 30 confine a plurality of cation beads 41 to the second capillary 29. As shown in FIG. 9, a negative electrode 19 is engaged to the first capillary 27 and a positive electrode 17 is engaged to the second capillary 29. As in previously described embodiments, activating the electrodes generates an electroosmotic flow in the first capillary 27 and the second capillary 29 and generates a hydrodynamic flow in the field free capillary 31.

In the alternative embodiment of the invention depicted in FIG. 9, the electroosmotic pump utilized capillaries instead of the microfluidic format. The electroosmotic flow pump was first fabricated with capillaries and a T-connector (Upchurch scientific). The first capillary 27 and the second capillary 29 were each about 200 μm in inner diameter. The first capillary 27 was packed with 5 μm anion beads 43 and the second capillary 29 was packed with 5 μm cation beads 41. Those skilled in the art will recognize that various inner diameters for the first capillary 27 and the second capillary 29 are different size beads are within the spirit and scope of the present invention.

The frits 25, 26, 28, and 30 of this embodiment are about 1 mm in length. The first capillary 27 of this embodiment is about 80 mm in length. In one embodiment, about 50 mm of the first capillary 27 comprises the plurality of anion beads 43. Additionally, the second capillary 29 of this embodiment is about 80 mm in length. In one embodiment, about 50 mm of the second capillary 29 comprises the plurality of cation beads 41. In this embodiment, the field free capillary 31 is about 150 mm in length and comprises an inner diameter of about 50 μm. Those skilled in the art will recognize that various lengths and diameters of the various capillaries of this embodiment are within the spirit and scope of the present invention. In the embodiment of FIG. 9, the field free capillary 31 was intersected to the first capillary 27 and the second capillary 29 using a Micro Static Mixing Tee (Upchurch Scientific). A micropipette was used to measure the volumetric flow rate in the forward direction out of the field free capillary 31 at various applied voltages. To measure the reverse flow rate, the electrode polarity was reversed and a solution of mesityl oxide was placed at the end of the field free capillary 31. The reverse flow rate was determined by measuring the time it took the mesityl oxide to reach a UV absorbance detector. The field free capillary 31 was originally filled with 25 mM phosphate buffer at pH 6.8. The mesityl oxide was detected at 210 nm using a UV absorbance detector (HyperQuan Inc., Colorado Springs, Colo.) for the capillary embodiment.

In the embodiment of the present invention shown in FIG. 9, a maximum flow rate of about 3 μL/min was obtained at an applied voltage of 7.5 kV. The maximum flow rate is slightly higher than the maximum flow rate for the microchip electroosmotic flow pump (described earlier), since the total surface area of the capillary system is higher than that of the microchip. Higher applied voltages produce higher flow rates, but the maximum applied voltage was limited by Joule heating, which causes bubble formation and current breakdown in the capillary packed with beads.

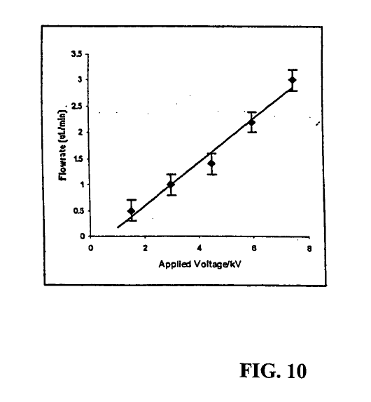

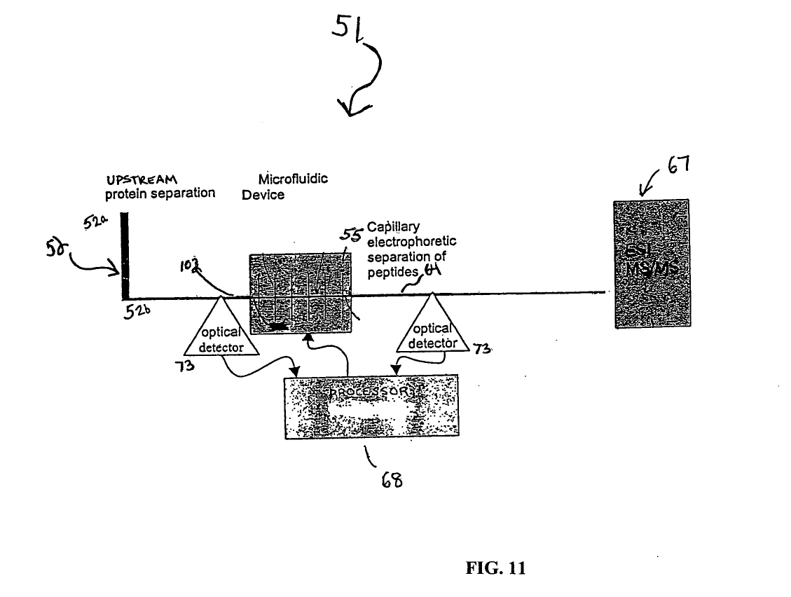

FIG. 10 is a graph showing that the flow rate of the embodiment depicted in FIG. 9 was found to be directly dependent on the applied voltage. Higher flowrates can be achieved by increasing the cross-sectional area of the pumping channels while the higher pressures can be achieved by decreasing the particle size. However, increasing the radius or dimensions of the first capillary 27 or the second capillary 29 while higher pressures may be achieved by decreasing the bead size. However, increasing the radius or dimensions of the capillaries 27, 29 reduces the surface area to volume ratio, which decreases the heat dissipation. The decreased heat dissipation increases the temperature gradient caused by Joule heating, which can cause bubble formation in the packed capillaries 27, 29.

An alternative set-up was used to measure the volumetric flowrates out of the reservoir of the field free capillary 31 when negative pressure was applied to this capillary 31 by reversing the polarity and generating electroosmotic flow in opposite directions for the cation and anion pumping capillaries 27, 29. Mesityl oxide (“MO”) reached the detector in about 66.7 s. The end of the field free capillary 31 was re-immersed in the buffer solution vial, and it took 68.7 s for the phosphate buffer to reach a detector (not shown). The volumetric flowrate of MO and phosphate buffer for the electroosmotic pump were found to be about 0.7 μL/min for an applied voltage of 2.4 kV, which closely matches the flowrate for positive pressure shown in FIG. 10. These results demonstrate that the electroosmotic pump is capable of pulling a plug of solution into an electroosmotic flow stream. Such a result is important for transporting a liquid that cannot normally move by electroosmosis.

The present invention comprises a novel microchip based electroosmotic pump capable of operating at a wider pH values of at least about 3 to about 10. A design that improves the volumetric flowrates at extreme pH values has been described. A maximum flowrate of up to 2 μL/min have been achieved using phosphate buffer at pH 6.8. The electroosmotic pump is fabricated using standard photolithography and wet chemical etching techniques allowing for easy and reproducible fabrication of microchips. Weirs have been fabricated within the microchip channels, eliminating the use of frits inside the channels to hold the beads and any frit synthesis that introduces polymer leachates and contaminants. The electroosmotic pump of the present invention has the capability of pumping non-conductive and highly conductive liquids to microreactors by the use of negative pressure applied to a reservoir containing the solution. It is expected that the electroosmotic pump will be utilized in future microfluidic systems such as reagent delivery, sample infusion for ESI-MS, flow injection analysis, and separations.

### Incorporating the EOF Pump with an Integrated Microfluidic Proteomic Analysis System

In a preferred embodiment of the present invention, the EOF pump described above is incorporated into a microfluidic device wherein the microfluidic device is incorporated into an Integrated Microfluidic Proteomic Analysis System. The Integrated Microfluidic Proteome Analysis System of the present invention is disclosed in Assignee's co-pending applications U.S. patent application Ser. No. 10/273,494, filed Oct. 18, 2002 and U.S. Patent Application Ser. No. 60/434,746, filed Dec. 18, 2002, the entirety of these applications are incorporated herein.

An integrated microfluidic proteomic analysis system of the present invention is shown generally at 51 in FIG. 11. A preferred embodiment of the integrated proteomic analysis system 51 comprises an upstream separation module 52, preferably a multi-dimensional chromatography apparatus including one or more separation columns (e.g., 52a, 52b, etc.) terminating with a capillary electrophoresis separation interfaced with at least one microfluidic device 55. The microfluidic device 55 includes an entrance channel 102 for receiving a substantially purified polypeptide from the upstream separation module 52. In an embodiment of the present invention, the microfluidic device 55 is covered by an overlying substrate (e.g., a coverglass, not shown) which comprises openings communicating with the one or more channels of the microfluidic device 55 and through which solutions and/or reagents can be introduced into the channels. As to be discussed below, Edman degradation takes place on the microfluidic device 55. In a preferred embodiment, the EOF pump described above is incorporated onto the microfluidic device 55.

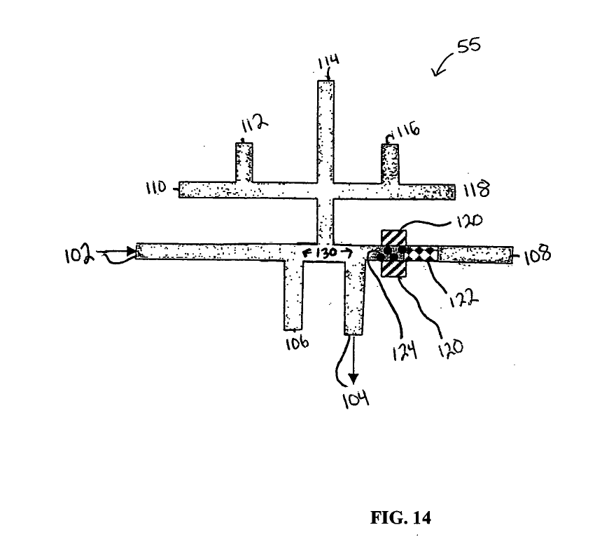

FIG. 14 displays an overview of the microfluidic device 55 of the present invention. The microfluidic device 55 comprises a plurality reagent reservoirs 110, 112, 114, 116, and 118. The overlying substrate also maintains the microfluidic device 55 as a substantially contained environment, minimizing evaporation of solutions flowing through the various channels of the microfluidic device 55. In one embodiment, the device comprises open channels.

In a preferred embodiment of the present invention, a substantially purified polypeptide is confined to an at least one reaction channel 130 of a microfluidic device 55. In a preferred embodiment of the present invention, the substantially purified polypeptide undergoes an Edman degradation reaction while confined in the at least one reaction channel 130. The Edman degradation comprises a cleavage reaction producing a cleavage product. In a preferred embodiment of the invention, the cleavage product is a terminal amino acid of the substantially purified polypeptide.

As shown in FIG. 11, as the cleavage product travels through the reaction channel 130 of the microfluidic device 55, the cleavage product is concentrated in the reaction channel 130 before being removed from the reaction channel 130. In an embodiment of the invention, the microfluidic device 55 is coupled at its downstream end to a downstream separation module 64 (e.g., such as a capillary electrophoresis) which collects the cleavage products and which can further separate the cleavage product from a by-product of the cleavage reaction. In a preferred embodiment, the cleavage product is a single cleaved amino acid produced from a single cycle of an Edman degradation. The cleavage product is sent to the downstream separation module 64 wherein the downstream separation module 64 isolates the single cleaved amino acid. In a preferred embodiment, the downstream separation module 64 is in communication with a processor 68 which identifies the single cleaved amino acid. In a preferred embodiment, a second cycle of the Edman degradation is initiated once the cleaved amino acid of the first cycle has been removed from the reaction channel and has been identified by the processor 68. The cycles of Edman degradation continue until each amino acid of the substantially purified amino acid has been identified or until the signal generated by the cleaved amino acids are below the detection limit.

In an embodiment of the present invention, the downstream separation module 64 is in communication with a peptide analysis module 67 (e.g., an electrospray tandem mass spectrometer or ESI-MS) which is used to collect information relating to the properties of the individual cleavage products.

In an embodiment of the present invention, the integrated microfluidic proteomic analysis system 51 comprises a system processor 68 which can convert electrical signals obtained from different modules of the integrated microfluidic proteomic analysis system 51 (and/or from their own associated processors or microprocessors) into information relating to separation efficacy and the properties of the substantially separated purified polypeptides as they travel through different modules of the system. In an embodiment, the system processor 68 also monitors the rates at which proteins/peptides move through different modules of the system. In an embodiment, signals are obtained from one or more detectors 73 which are in optical communication with different modules and/or channels of the system 51.

The integrated microfluidic proteomic analysis system 51 can vary in the arrangements and numbers of components. For example, the number and arrangement of detectors 73 can vary. In an embodiment, the microfluidic device 55 can interface directly with the peptide analysis module 67 without connection to an intervening downstream separation module 64. In another embodiment, the microfluidic device 55 also can perform separation, eliminating the need for one or more separation functions of the upstream separation module 52. In an embodiment, a digested or partially digested substantially purified polypeptide can be delivered to the microfluidic device 55 after being obtained from a protease digestion device not connected to the integrated proteomic analysis system 51, or in a less preferred embodiment, after being obtained from an on-gel digestion process.

In another embodiment, although the integrated proteomic analysis system 51 is described as being “integrated” in the sense that the different modules complement the other modules' functions, various components of the integrated microfluidic proteomic analysis system 51 can be used separately and/or in conjunction with other systems. In an embodiment, components selected from the group consisting of: the upstream separation module 52, the microfluidic device 55, and downstream separation module 64, and combinations thereof, can be used separately. In another embodiment, some modules can be repeated within the integrated proteomic analysis system 51, e.g., there may be more than one upstream and/or downstream separation module (52 and/or 64), more than one microfluidic device 55, more than one detector 73, and more than one peptide analysis module 67 within the integrated microfluidic proteomic analysis system 51. It should be obvious to those of skill in the art that many permutations are possible and that all of these permutations are encompassed within the scope of the present invention.

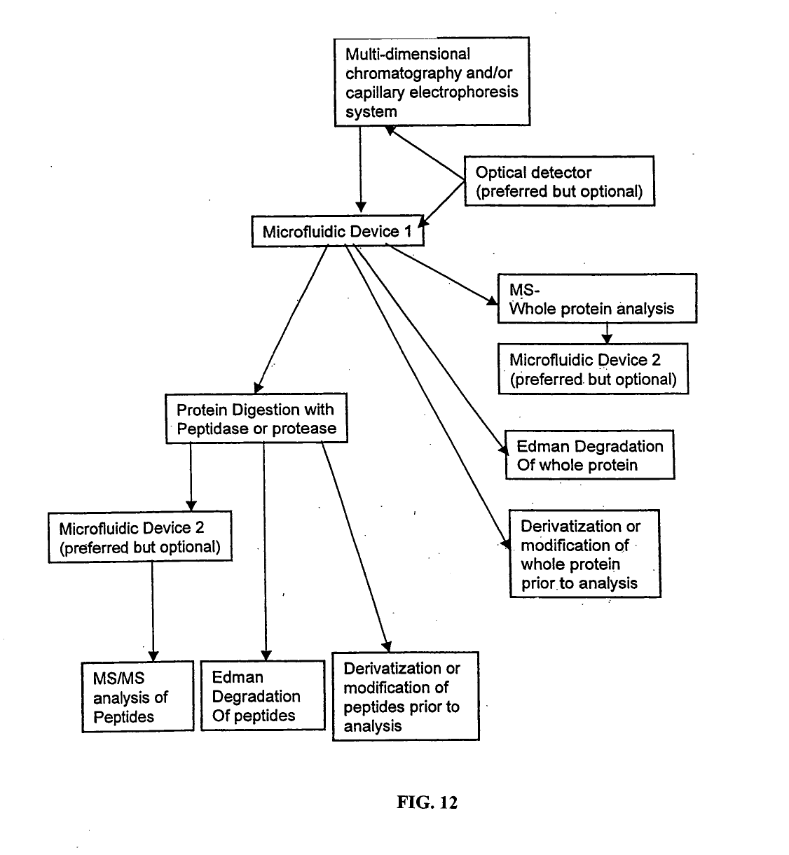

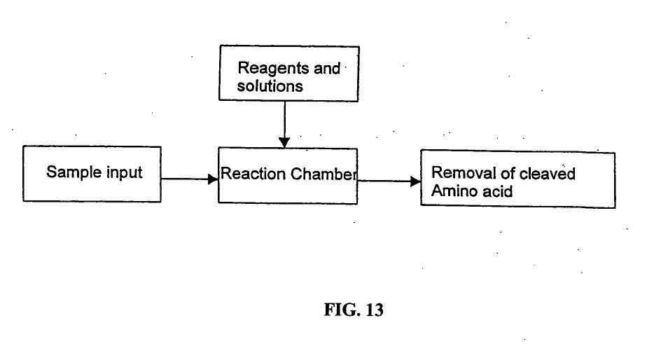

As shown in FIG. 12, the present invention may be used in conjunction with “Microfluidic System For Proteome Analysis”, as disclosed in the Assignee's co-pending Provisional Patent Application, U.S. Ser. No. 60/344,456, the entirety of which is incorporated herein by reference. As shown, in one embodiment, the present invention may be used to perform Edman degradation on a substantially purified polypeptide delivered to the microfluidic device via an upstream separation module 52. In another embodiment, the substantially purified polypeptide is first digested on a first microfluidic device and subsequently delivered to a second microfluidic device capable of performing Edman degradation on the partially digested protein.

The following sections will briefly review the components of the Integrated System For Proteome Analysis.

### Upstream Separation Module

In a preferred embodiment of the present invention, the upstream separation module 52 comprises a multi-dimensional column separation apparatus. In multi-dimensional separations, samples are separated in at least two-dimensions in accordance with different criteria. For example, in a first dimension, components in a sample may be separated using isoelectric focusing providing information relating to the isoelectric point of a component of interest and in the second dimension, components having the same isoelectric point can be separated further according to molar mass.

As shown in FIG. 11, the upstream separation module 52 of the invention comprises at least a first separation path 52a and a second separation path 52b. In an embodiment, at least one of the separation paths is a capillary. In another embodiment, both separation paths are capillaries. The first separation path 52a and second separation path 52b comprise a first and a second separation medium.

In another embodiment of the invention, the first separation path is a capillary coupled to an injection apparatus (e.g., such as a micropipettor, not shown) which injects or delivers a sample including a mixture of polypeptides to be separated into the first separation medium. In a preferred embodiment of the invention, a sample comprises a lysate of cell(s), tissue(s), organism(s) (e.g., microorganisms such as bacteria or yeast) and the like. In a preferred embodiment of the present invention, a sample comprises a lysate of abnormally proliferating cells (e.g., such as cancerous cells from a tumor). The sample also can comprise subcellular fractions such as those which are enriched for particular organelles (e.g., such as nuclei or mitochondria). In an embodiment of the present invention, the proteins are concentrated prior to separation. In a preferred embodiment, the sample which is injected into the first separation medium comprises micrograms of polypeptides.

One or more electrodes (not shown) coupled at least at a first and second end of the first separation path 52a is used to create an electric field along the separation path. In an embodiment of the invention, a second separation path 52b connects to the first separation path 52a, receiving samples from the first separation path 52a which have been substantially separated according to a first criteria. Passage of the separated samples through the second separation path 52b substantially separates these samples according to a second criteria. Multiple parallel separation paths 52b also can be provided for separating samples in parallel. Systems and methods for controlling the flow of samples in separation paths are described in U.S. Pat. No. 5,942,093.

The region of intersection of the first and the second separating paths, 52a and 52b, respectively, forms an injection apparatus for injecting the sample substantially separated according to the first criteria into the second separation medium. If capillary electrophoresis is used for the separation 52b, an electric field applied along the second separating path 52b then causes the samples substantially separated according to the first criteria to become substantially separated according to the second criteria. In an embodiment of the invention, one or more waste paths (not shown) are provided to draw off unwanted carrier medium (see, e.g., as described in U.S. Pat. No. 5,599,432).

Additional separation paths can be provided downstream of the first separation path 52a, for example, connected to the second separation path 52b or between the first separation path 52a and the second separation path 52b. Each of these additional paths can perform separations using the same or different criteria as upstream separation paths.

In an embodiment of the present invention, at least one separation medium in at least one separation path is used to establish a pH gradient in the path. In an embodiment, ampholytes can be used as the first separation medium. The first separation path 52a can be connected at one end to a reservoir portion (not shown) and at the other end to a collecting path (not shown) proximate to the intersection point between the first and second path. Electrodes can be used to generate an electric field in a reservoir including the ampholyte and in the collecting path. The acidic and basic groups of the molecules of the ampholyte will align themselves accordingly in the electric field, migrate, and in that way generate a temporary or stable pH gradient in the ampholyte.

Different separating paths, reservoirs, collecting paths, and waste paths can be isolated from other paths in the upstream separation module 52 using valves operating in different configurations to either release fluid into a path, remove fluid from a path, or prevent fluid from entering a path (see, e.g., as described in U.S. Pat. No. 5,240,577, the entirety of which is hereby incorporated by reference). Controlling voltage differences in various portions of the upstream separation module 52 also can be used to achieve the same effect. In a preferred embodiment, the opening or closing of valves or changes in potential is controlled by the processor 68, which is further in communication with one or more detectors 73 which monitors the separation of components in different paths within the module 52 (see, e.g., as described in U.S. Pat. No. 5,240,577).

In this way, the first separating path 52a can be used to perform isoelectric focusing while the second separating path 52b can be used to separate components by another criteria such as by mass. It should be obvious to those of skill in the art that isoelectric focusing also could be performed in the second path 52b while separation by mass could be performed in the first path by changing the configuration of the reservoir and collecting path. In another embodiment of the present invention, multiple different pH gradients can be established in multiple different separation paths in the upstream separation module 52.

The choice of buffers and reagents in the upstream separation module 52 will be optimized to be compatible with a downstream system with which it connects, such as a microfluidic device 55 which can perform Edman degradation of the substantially purified polypeptides (described further below). In a preferred embodiment, a buffer is selected which maintains polypeptide/peptide solubility while not substantially affecting reactions occurring in the downstream system (e.g., such as cleavage and ultimately, amino acid analysis). In an embodiment, low concentrations of acetonitrile (ACN) and solubizing agents such as urea and guanidine can be used as these will not affect analyses such as ionization (such as would occur in the downstream peptide analysis module 67). When a CE column is used as an upstream separation module, a solid-phase extraction (SPE) CE system that incorporates an SPE bead can be provided upstream of the CE column, enabling buffers to be changed and samples to be concentrated prior to CE separation. Commercially available chromatography beads have been designed specifically for the extraction of proteins from detergent containing solutions (Michrom Bioresources, Auburn, Calif.). Elution from the SPE also can achieved with ACN.

In a preferred embodiment of the invention, at least one separation is performed which relies on size-exclusion, e.g., such as size-exclusion chromatography (SEC) (see, e.g., Guillaume, et al., 2001, Anal. Chem. 73(13): 3059-64). Ion-exchange also can be employed and has the advantage of being a gradient technique. Both of these separations are compatible with the surfactants and denaturants used to maintain protein solubility. In another embodiment of the invention, at least one separation is a chromatofocusing (CF) separation. CF separates on the basis of isoelectric point (pI) and can be used to prepare milligram quantities of proteins (see, e.g., Burness et al., 1983, J Chromatogr. 259(3): 423-32; Gerard et al., 1982, J. Immunol. Methods 55(2): 243-51. In a preferred embodiment, SEC is performed in the first separating path 2a, and CF is performed in the second separating path 2b, achieving a level and quality of separation similar to 2DE.

Parallel separations can be incorporated readily into the integrated microfluidic proteomic analysis system 51 according to the invention, as a microfluidic device 55 including up to about 96 channels or more have been fabricated (see, as described in, Simpson et al., 1998, Proc. Nat. Acad. Sci. USA 95: 2256-2261; Liu et al., 1999, Analytical Chemistry 71: 566-573, for example).

Because the upstream separation module 52 preferably is used to concentrate macrovolumes (i.e., microliters vs. nanoliters) including micrograms of sample, it is preferred that at least one component of the upstream separation module 52 be able to concentrate macrovolume samples and separate polypeptides within such sample. In a preferred embodiment of the invention, therefore, the upstream separation module 52 comprises one or more chromatography columns, preferably, at least one capillary electrochromatography column.

In an embodiment, the separation path can comprise a separation medium including tightly packed beads, gel, or other appropriate particulate material to provide a large surface area over which a fluid including the sample components can flow. The large surface area facilitates fluid interactions with the particulate material, and the tightly packed, random spacing of the particulate material forces the liquid to travel over a much longer effective path than the actual length of the separation path. The components of a sample passing through the separation path interact with the stationary phase (the particles in the separation path) as well as the mobile phase (the liquid eluent flowing through the separation path) based on the partition coefficients for each of the components in the fluid. The partition coefficient is a defined as the ratio of the concentration of a component in a stationary phase to the concentration of a component (e.g., a polypeptide or peptide) in a mobile phase. Therefore, components with large partition coefficients migrate more slowly through the column and elute later.

In a preferred embodiment of the invention, chromatographic separation in the upstream separation module 52 is facilitated by electrophoresis. Preferably, the separation occurs in tubes such as is used in capillary electrochromatography (CEC).

CEC combines the electrically driven flow characteristics of electrophoretic separation methods with the use of solid stationary phases typical of liquid chromatography, although smaller particle sizes are generally used. It couples the separation power of reversed-phase liquid chromatography with the high efficiencies of capillary electrophoresis. Higher efficiencies are obtainable for capillary electrochromatography separations over liquid chromatography. In contrast to electrophoresis, capillary electrochromatography is capable of separating neutral molecules due to analyte partitioning between the stationary and mobile phases of the column particles using a liquid chromatography separation mechanism.

In CEC, the stationary phase can be either particles which are packed into capillary tubes (packed CEC) or can be attached (i.e., modified or coated) onto the walls of the capillary (open tubular or OTEC). The stationary phase material is similar to that used in micro-HPLC. The mobile phase, however, is pumped through the capillary column using an applied electric field to create an electroosmotic flow, similar to that in CZE, rather than using high pressure mechanical pumps. This results in flat flow profiles which provide high separation efficiencies. Therefore, in a currently preferred embodiment of the present invention, at least one component of the upstream separation module 52 comprises one or more CEC columns.

CEC systems can also be provided as part of a microfluidic device. See, as described in Jacobson et al., 1994, Anal. Chem. 66: 2369-2373, for example.

### Microfluidic Device for Edman Degradation of a Peptide or Polypeptide

In a preferred embodiment of the present invention, the microfluidic device 55 comprises a biocompatible substrate such as silicon or glass and the microfluidic device 55 comprises a plurality of reaction channels 130. In another embodiment of the present invention, the microfluidic device 55 is comprised of a polymer. In one embodiment, the device 55 is comprised of PDMS. In another embodiment, the device 55 is comprised of PMMA. Those skilled in the art will recognize that various polymers may be used and be within the spirit and scope of the present invention. Preferably, the microfluidic device 55 comprises at least about 2, at least about 4, at least about 8, at least about 16, at least about 32, at least about 48, or at least about 96 reaction channels 130. Reaction channels 130 can vary in size and are generally from about 50 μm-200 μm wide (preferably, from about 80 μm-100 μm wide) and from about 5 μm-40 μm deep (preferably from about 10 μm-30 μm deep). The microfluidic device 55 is not necessarily planar and may be represented in a three-dimensional channel network. In a most preferred embodiment, the microfluidic device 55 is circular in shape.

The microfluidic device 55 may comprise varying channel geometries. In an embodiment, the microfluidic device 55 comprises an entrance channel 102 which divides into a plurality of substantially parallel reaction channels 130. However, the absolute channel geometry is not critical so long as the appropriate fluid flow relationships are maintained. In an embodiment, the various channels may be curved. In an embodiment, the substrate itself is not planar and the various channels may be non-coplanar (e.g., radiating from a central intersection channel as spokes from a central hub). Many refinements to the geometry of the channel layout can be made to increase the performance of the device and such refinements are encompassed within the scope of the invention. In an embodiment, shorter channels will decrease the distance over which sample bands must be transported, but generally channels need to be long enough to hold the sample bands, and to provide adequate separation between electrodes in contact with channels (discussed further below) to prevent current feedback.

The microfluidic device 55 can be substantially covered with an overlying substrate for maintaining a substantially closed system (e.g., resistant to evaporation and sample contamination) (not shown). The overlying substrate can be substantially the same size as the microfluidic device 55, but at least is substantially large enough to cover the reaction channels 130 of the microfluidic device 55. In an embodiment of the invention, the overlying substrate comprises at least one opening for communicating with the microfluidic device 55. The openings can be used to add reagents or fluid to the microfluidic device 55. In a preferred embodiment of the invention, openings can be used to apply an electric voltage to different channels in communication with the openings.

Suitable materials to form the overlying substrate comprise silicon, glass, plastic or another polymer. In an embodiment of the invention, the overlying substrate comprises a material which is substantially transmissive of light. The overlying substrate can be bonded or fixed to the microfluidic device 55, such as through anodic bonding, sodium silicate bonding, fusion bonding as is known in the art or by glass bonding when both the microfluidic device 55 and overlying substrate comprise glass (see, e.g., as described in High Technology, Chiem et al., 2000, Sensors and Actuators B 63: 147-152).

As shown in FIG. 14, an embodiment of the invention comprises a microfluidic device 55 accepting a substantially purified polypeptide from an upstream separation module via an entrance channel 102. In a preferred embodiment of the invention, a reaction channel 130 engages the entrance channel 102 wherein the substantially purified polypeptide is delivered to the reaction channel 130. Once the substantially purified polypeptide enters the reaction channel 130, the substantially purified polypeptide is confined to the reaction channel 130.

In an embodiment of the present invention, a solid support inside the reaction channel 130 engages the substantially purified polypeptide thereby confining the substantially purified polypeptide to the reaction channel 130. The substantially purified polypeptide is confined to the reaction channel 130 through immobilization on a solid support which is also confined to the reaction channel 130. Because the solid support is orders of magnitudes larger in size than the substantially purified polypeptide, attachment of the substantially purified polypeptide to the solid support facilitates confining the substantially purified polypeptide to the reaction channel 130.

In an embodiment of the present invention, the solid support is a membrane 122. In an embodiment of the present invention, the solid support is a poly-vinylidene flouride (“PVDF”) membrane 122. In another embodiment of the present invention, the membrane is a cellulose membrane 122.

In a preferred embodiment of the invention, the solid support is an ultrafiltration membrane 122. Ultrafiltration is a membrane process which will retain soluble macromolecules and every thing larger while passing solvent, ions, and other small soluble species. Ultrafiltration is almost always operated with some means of forced convection near the membrane. Cross-flow filtration is practically universal for ultrafiltration.

In a preferred embodiment of the present invention, an ultrafiltration membrane 122 confines a substantially purified polypeptide to the reaction channel 130. In another embodiment, the substantially purified polypeptide is not immobilized on a solid support. The substantially purified polypeptide remains in solution in the reaction channel 130. In an embodiment, a cleavage product is allowed to pass through the ultrafiltration membrane 122 while the ultrafiltration membrane 122 confines the substantially purified polypeptide to the reaction channel 130.

In a preferred embodiment of the invention, the solid support comprises a plurality of beads 124. The plurality of beads 124 can be divided into two types: magnetic and non-magnetic. A supplier of the magnetic beads is Dynal Biotech. The non-magnetic beads are available from numerous sources who supply beads for chromatography.

The plurality of beads 124 can be packed into a reaction channel 130 of a microfluidic device 55 by applying voltages at selected channels to drive the plurality of beads 124 into the desired reaction channels 130. In an embodiment, the plurality of beads 124 comprise charged surface molecules (e.g., such as free silonol groups) to facilitate the process of packing the plurality of beads 124 into a reaction channel 130. For example, electroosmotic flow driven by walls of the reaction channel 130 and free silonol groups on the plurality of beads 124 can be used to effect packing. In an embodiment, a voltage of from about 200-800 V for about 5 minutes at a reaction channel 130 while remaining, non-selected channels are grounded, is sufficient to drive the plurality of beads 124 into a selected reaction channel 130. Packing of a plurality of beads 124 also may be performed electrokinetically as described in U.S. Pat. No. 5,942,093, which is hereby incorporated by reference.

In an embodiment of the invention, using bead injection technology for the addition and removal of the plurality of beads 124 from the reaction channel 130 allows for the introduction of new beads that are activated for a covalent attachment of the substantially purified polypeptide and will result in minimal carry-over (see, e.g., Ruzicka and Scampavia, 1999 Anal. Chem. 71(7): 257A-263A; Oleschuk et al., 2000, Anal. Chem. 72(3): 585-590).

In another embodiment of the invention, the plurality of beads 124 are magnetic, paramagnetic or superparamagnetic, and can be added to or removed from a reaction channel 130 of the microfluidic device 55 by using a magnetic field applied to selective regions of the microfluidic device 55.

In a preferred embodiment of the invention, the substantially purified polypeptide engages to the plurality of beads 124. For standard silica chromatography beads the same chemistry can be used to engage the plurality of beads 124 to the substantially purified polypeptide as was disclosed in Aebersold et al (Analytical Biochemistry, 56-65, 1990). Aebersold discloses using N-ethyl-N′-(3-dimethylaminopropyl) carbodiimide (EDC) to activate the carboxylic acid terminus and aminophenyltriethoxysilane (APTE) to activate the silica surface. Other activated beads which can bind covalently to a carboxylic acid group and can be used for N-terminal sequencing, and any activated bead which can bind covalently to a primary amine can be used for C-terminal sequencing. Both covalent and non-covalent methods for immobilization of the substantially purified polypeptide are known in the art.

In an embodiment of the invention, the substantially purified polypeptide is engaged to the plurality of beads 124 at a C-Terminal end of the plurality of polypeptides. In another embodiment of the invention, the substantially purified polypeptide is engaged to the plurality of beads 124 at a N-Terminal end of the substantially purified polypeptide. In a preferred embodiment of the invention, the substantially purified polypeptide is covalently bonded to the plurality of beads 124.

In a preferred embodiment of the present invention, the plurality of beads 124 are confined to the reaction channel 130. In an embodiment of the invention, the plurality of beads 124 are magnetic. In an embodiment, an external force is applied to the plurality of beads 124 in order to confine the plurality of magnetic beads 124 to the reaction channel 130. In another embodiment, a plurality of magnets 120 are used to confine the plurality of magnetic beads 124 to the reaction channel 130.

In another embodiment of the present invention, the reaction channel 130 comprises a blocking structure which blocks the solid support from exiting the reaction channel 130. The blocking structures can be classified into two main groups that are differentiated based on the size regimes of the pores or openings in the blocking structure.

In an embodiment of the present invention, a weir confines the plurality of beads 124 to the reaction channel 130. Weirs, posts, constricters, and filters fabricated in the reaction channel 130 are in the larger class of structures that will block the plurality of beads 124, but do not impede the flow of a cleavage product or the substantially purified polypeptide. Liquid flow in an open channel may be slowed by means of a weir, which consist of a dam over which, or through a notch in which, the liquid flows. The terms “rectangular weir,” “triangular weir,” etc., generally refer to the shape of the notch in a notched weir.

In a preferred embodiment of the invention, an ultrafiltration membrane 122 is used to confine the plurality of beads 124 to the reaction channel 130. An ultrafiltration membrane is a member of the second class of smaller structures. The second class of smaller structures impedes the movement of the plurality of beads 124, the substantially purified polypeptide and sometimes the cleavage product. Ultrafiltration membranes are commercially available in different materials. In an embodiment of the invention, an ultrafiltration membrane 122 is incorporated into the reaction channel 130 for the purpose of confining a plurality of beads 124 to the reaction channel 130. In another embodiment, an ultrafiltration membrane 122 confines a plurality of beads 124 and the substantially purified polypeptide as well as a cleavage product to the reaction channel 130.

In a preferred embodiment of the present invention, a plurality of magnets 120 and an at least one ultrafiltration membrane 122 are used together in order to confine a plurality of beads 124 to the reaction channel 130.

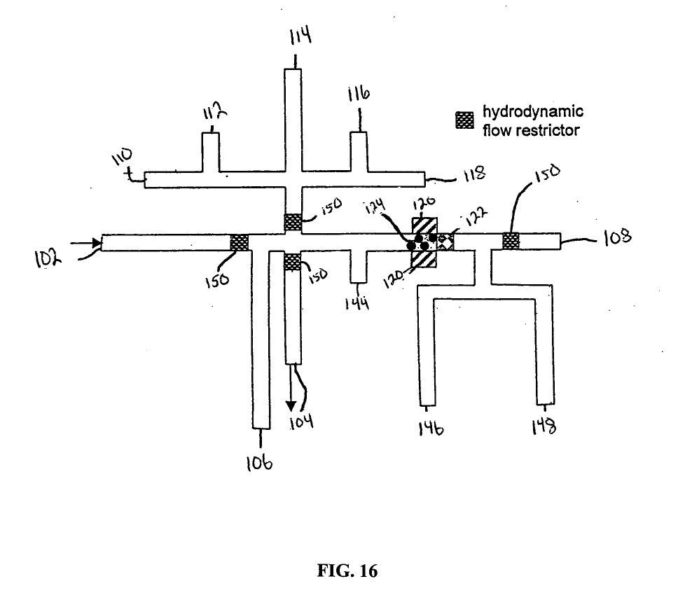

The microfluidic device 55 of the present invention is capable of various configurations. FIG. 14 shows an embodiment of the present invention wherein a substantially purified polypeptide enters the reaction channel 130 via an entrance channel 102 which is in communication with an upstream separation module 52. Once inside the reaction channel 130, the substantially purified polypeptide is engaged to a plurality of magnetic beads 124. The plurality of magnetic beads 124 are confined to the reaction channel 130 by applying an external force. In the embodiment of FIG. 16, a plurality of magnets 120 apply the external force to the plurality of magnetic beads 124.

As shown in FIG. 14, the present invention can further comprise an ultrafiltration membrane 122. The plurality of magnetic beads 124, the substantially purified polypeptide, and the cleavage products are all concentrated at the ultrafiltration membrane 122. The ultrafiltration membrane 122 impedes the flow of the plurality of magnetic beads 124, the substantially purified polypeptide, and the cleavage products. Once the cleavage product has been concentrated at the ultrafiltration membrane 122, the cleavage product leaves the reaction channel 130 via the exit channel 104. FIG. 16 also illustrates a channel 106 for the introduction and for the removal of a plurality of beads 124 and a connection 108 to an auxiliary electrode.

FIG. 14 also shows a plurality of channels which connect to the reaction reservoirs 110, 112, 114, 116, and 118 wherein each reaction reservoir engages the reaction channel 130. In an embodiment, each reaction reservoir 110, 112, 114, 116, and 118 contains a unique reagent. In a preferred embodiment of the present invention, each unique reagent is critical to a step of Edman degradation. When covalent coupling of the polypeptide is performed, a coupling reagent, such as EDC, would occupy one of the reservoirs. In a preferred embodiment of the present invention, the reagents are pumped into the reaction channel (analogous to the filed free channel discussed above) from the reaction reservoirs utilizing the EOF pump discussed above.

### Utilizing the EOF Pump for the Process of Edman Degradation

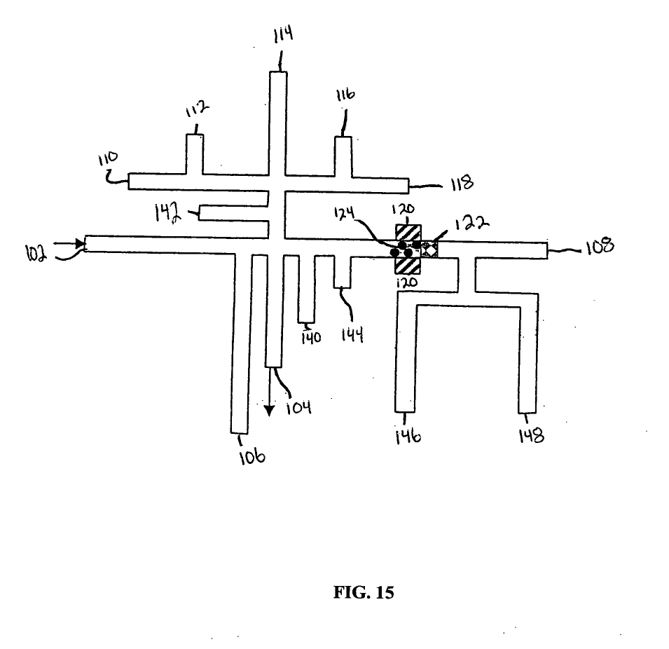

Certain chemical reactions may be facilitated by the use of electroosmotic flow; more specifically, certain reactions are facilitated by producing a field free channel 13 (as discussed above) in the reaction channel 130. Edman degradation is one of those reactions. The EOF pump of the current invention allows for the creation of a field free reaction channel and for the use of electroosmotic flow. FIGS. 15, 16 and 17 described below show the addition of columns 146 and 148 to the microfluidic device 55. These columns are the equivalent to the first column 5 and the second column 9 described earlier. The use of these columns allows for the reaction channel 130 to be free of charge and draws a reagent from the column marked 144. In a preferred embodiment, the reagent drawn from the column marked 144 and pulled through the membrane 122 is TFA. As such, the use of the EOF pump of the current invention allows for the use of electroosmotic flow to power an Edman degradation reaction (wherein prior art EOF pumps could not due to the charge on the reagents necessary for Edman degradation).

First, please find below a brief description of the process for performing Edman degradation on a microfluidic chip; next, please find a description of FIGS. 15, 16 and 17 which describe how the EOF pump was incorporated into a microfluidic chip and how the EOF pump of the present invention facilitates the Edman degradation reaction.

Once the substantially purified polypeptide enters the reaction channel 130, the substantially purified polypeptide is confined to the reaction channel 130. The present invention provides a method of performing Edman degradation on the substantially purified polypeptide while it is confined to the reaction channel.

Edman degradation has been used for sequencing proteins and peptides since its introduction by Pehr Edman. The Edman degradation method for peptide and protein sequencing is based on the cyclic removal and identification of the terminal amino acid. The Edman degradation is based on a labeling reaction between the terminal amino group and phenyl isothiocyanate, C₆H₅N═C═S. When the labeled polypeptide is treated with acid, the terminal amino acid residue splits off as an unstable intermediate that undergoes rearrangement to a phenylthiohydantoin. This last product can be identified by comparison with phenylthiohydantoin prepared from standard amino acids. If both the unstable intermediate and the phenylthiohydantoin are present, both species can be detected simultaneously, making the conversion step optional. The sequence of the substantially purified polypeptide is then elucidated by cycling the protein or peptide through many stages of removal and sequential identification of the terminal amino acid residue.

To achieve the stepwise activation of a terminal amino acid, the cleavage of the terminal amino acid, and the subsequent identification of each cleaved terminal amino acid the appropriate chemistry must be applied. Many varied chemistries have been developed for this purpose. These different methods have been developed primarily to enable different detection schemes, to improve the limits of detection, or to decrease the reaction time.

The solvent systems used for the reagents during Edman degradation often include non-polar organic solvents, such as heptane. These solvents are not amenable to electroosmotic flow and due primarily to their low degree of polarity. In a preferred embodiment, solvents that produce relatively high levels of electroosmotic flow (EOF) are used. A relatively high level of EOF is crucial to a microfluidic device that relies primarily on EOF for transport of solutions.

Each cycle of Edman degradation consists of a series of chemical reactions effected by flowing different reagents over a peptide or polypeptide which is engaged to a solid support or a peptide or polypeptide remaining in solution. Many Edman degradation chemistries are based on coupling a reagent to a terminal amino acid in order to activate the terminal amino acid and the introduction of another reagent to cleave the activated terminal amino acid. Cleaving the terminal amino acid is followed by the steps of recovering the cleaved terminal amino acid and identifying the cleaved terminal amino acid.

The coupling step of an Edman degradation reaction is typically carried out by passing a first solution of an aqueous base over the protein or polypeptide followed by passing a second solution of the coupling reagent (usually phenylisothiocynate, “PITC”) in an organic solvent over the polypeptide. Additionally, the aqueous base and the coupling reagent solutions are often cycled through 2 or 3 times to improve the coupling reaction efficiency.

Phenylisothiocyanate (PITC) is the original coupling reagent used in Edman degradation, and is still the most widely used coupling reagent. However, other coupling reagents have been developed, usually for the purpose of improved detection. A list of some of the reagents that may be used with the present invention include, but are not limited to, the following: 7-N,N-dimethylaminosulfonyl-4-(2,1,3-benzoxadiazolyl)isothiocyanate (DBD-NCS); 7-[(N,N-dimethylamino)sulfonyl]-2,1,3-benzoxadiazol-4-yl isothiocyanate (DBD-NCS); 7-[(N,N-Dimethylamino)sulfonyl]-2,1,3-benzooxadiazol-4-yl Isothiocyanate; Fluorinated isothiocyanate; Fluorescein isothiocyanate (FITC); 4-(N-1-dimethylaminonaphthalene-5-sulfonylamino)phenyl isothiocyanate (DNSAPITC); 4-N,N-dimethylaminoazobenzene 4′-isothicyanate phenyllisothiocyanate (DABITC); 2-(4-isothiocyanatophenoxy)-1,3,2-dioxaphosphinane 2-oxide (PEPITC); 3-[4′(ethylene-N,N,N-trimethylamino)phenyl]-2-isothiocyanate (P(ETAP)TH); Para-Phenylazpphenylisothiocyanate (PAPITC); and Dansyl-amino PITC.

In a preferred embodiment, the two reagent solutions are combined into one by removing water. Thus the coupling is achieved with just one solution, which is made from 5% PITC in 35% acetonitrile, 62.5 methanol and 2.55 NMM.

In other embodiments of the present invention, the following solvent systems are used: 1) 5% PITC in Heptane and 2) 25% TMA in Isopropanol/Water 1/1 v/v; 5% PITC in NMM/CAN/MeOH/Water in the ratio 2.5/12.5/35/50; 10% PITC, 10% TEA in 70% ethanol-prepared immediately before use; 5% PITC in Heptane v/v; 5% TEA in Water v/v; 5% PITC in Heptane; Methyl piperidine in n-propanol and water (25:60:15); 5% PITC in Heptane; 12.5% TMA in Water; 5% PITC in Heptane; Quadrol/TFA in water/Propanol (4:3); 5% PITC in Heptane, 5% NMM in 70/30 Methanol/Water; 5% PITC in Heptane; 12.5% TMA in water; Methanol/Water/TMA/PITC 7:1:1:1 v/v.

The basic steps in an Edman degradation comprise: (1) washing a peptide or polypeptide to prepare the peptide or polypeptide for coupling of a cleavage reagent; (2) coupling of the cleavage reagent to a terminal amino acid of the peptide or polypeptide; (3) washing the coupled terminal amino acid in preparation for cleaving the terminal amino acid of the peptide or polypeptide; (4) cleaving the terminal amino acid of the peptide or polypeptide; (5) collecting the cleaved terminal amino acid of the peptide or polypeptide; (6) the continued washing of the peptide or polypeptide which will increase the collection efficiency of the cleaved amino acid; and (7) a conversion step in which a cleaved anilothiazlinone amino acid (ATZ-AA) is converted to a more stable phenylthiohydantion (PTH-AA) by means of an addition of heat and acid. In order to achieve efficient coupling of the cleavage reagent, it is common to repeat steps (1) and (2) before proceeding to step (3). Additionally, the washing of step (3) is often repeated prior to step (4) and the washing of step (6) is often repeated before returning to step (1) to begin the next cycle of Edman degradation.

In embodiments of the present invention, the following solvent systems are used in the wash step: 1) 66% Ethyl acetate and 2) Chlorobutane; 1) Methanol and 2) Ethyl acetate/Heptane 1/1 V/V; 1) Heptane/Ethyl acetate-15:1 and 2) Heptane/Ethyl acetate-7:1; Ethyl acetate; 1) Heptane and 2) ethyl acetate and 3) acetonitrile; 1) Benzene and 2) Ethyl acetate and 3) acetonitrile; 1) methanol and 2) Heptane/ethyl acetate 1/1 v/v; 1) Heptane and 2) Ethyl acetate and 3) chlorobutane; methanol.

In one embodiment of the present invention, anhydrous TFA is used as a cleavage reagent. In one embodiment of the invention, TFA is used as a cleavage reagent. In one embodiment of the invention, HFBA is used as the cleavage reagent.

In one embodiment of the present invention, chlorobutane is used as the extraction reagent. In one embodiment, heptane/ethyl acetate (5:1) is used as the extraction reagent. In one embodiment, TFA/phosphoric acid 42.5% (9:1 v/v) is used as the extraction reagent.

In the present invention, controlling the flow of reagents to the reaction channel 130 will control the rate of the reaction. In a preferred embodiment, an EOF pump of the current invention drives the reagents to the reaction channel 130.

In a preferred embodiment of the invention, the process of Edman degradation is used to cleave an N-terminal amino acid of the substantially purified polypeptide. In a preferred embodiment, a cleavage product of the Edman degradation is the N-terminal amino acid.

In a preferred embodiment of the present invention, the process of Edman degradation is used to cleave a C-terminal amino acid of the substantially purified polypeptide. In a preferred embodiment, a cleavage product of the Edman degradation is the C-terminal amino acid.

Concentrating the cleavage product in the reaction channel 130 allows for improved detection limits and speed. In a preferred embodiment of the present invention, a cleavage product is concentrated in the reaction channel 130 before the cleavage product exits the reaction channel 130 via an exit channel 104. In a preferred embodiment, a cleavage product is concentrated in the reaction channel 130 prior to being removed from the reaction channel 130. In an embodiment of the present invention, a reaction channel 130 comprises a membrane 126 which concentrates the cleavage product before the cleavage product is removed from the reaction channel 130.

In a preferred embodiment of the present invention, a cleavage product is concentrated in front of an ultrafiltration membrane 122 or 126 in the reaction channel 130 before the cleavage product is removed from the reaction channel 130. In another embodiment of the invention, the cleavage product is concentrated on a solid extraction apparatus 128 before the cleavage product is removed from the reaction channel 130. In a preferred embodiment of the present invention, the cleavage product is electrophoretically concentrated in the reaction channel 130 of the microfluidic device 55.

In a preferred embodiment, the second ultrafiltration membrane 126 comprises pores small enough to retain peptides while allowing buffer and current to pass through. In an embodiment, the membrane comprises pores having diameters ranging from about 2 to about 30 Å. In another embodiment, the membrane is a nanofiltration membrane which has a low rejection of monovalent and divalent ions but which preferentially rejects organic compounds with a molecular weight cut off in the 200 to 500 MW range or higher (i.e., such as peptides). Nanofiltration membranes are known in the art and are available from Osmonics® (at www.osmonics.com) for example.

In an embodiment, after an appropriate period of time, flow in the reaction channel 130 is reversed and a cleavage product is delivered to a downstream separation module 64 via an exit channel 104. The amount of time necessary to carry out the above-described reactions can be optimized further by varying the reaction solution, temperature, or by vibrating the microfluidic device 55.

As shown in FIG. 15, a preferred embodiment of the present invention comprises the aspects discussed with FIG. 14 and further includes channels 146,148 to facilitate the EOF pump of the present invention. FIG. 15 further shows an embodiment of the invention further comprising a first waste stream 140 and a second waste stream 142. In one embodiment, a trifluoroacetic acid (“TFA”) channel 144 is provided for the addition of TFA to the reaction channel 130. In one embodiment, an EOF Pump regulates fluid flow. A first reservoir 146 and a second reservoir 148 are connected to the channels which generate the fluid flow by EOF.

Since these channels 146, 148 are pulling solution from inside the reaction channels, the flow inside the reaction channels will be hydrodynamic flow which will pull solution from all of the intersecting channels. A plurality of flow restrictors minimize the contribution of flow from these intersecting channels. Minimizing flow from the intersecting channels will improve the purity of the TFA in the reaction channel. The flow restrictors can be many small channels in parallel or a macroporous frit-like material. Such macroporous materials will allow for the reagents and large molecules to move through them while increasing the resistance to hydrodynamic flow.

As opposed to the prior art, the EOF pump region (where the electric field is) of the present invention is not co-linear with field free or hydrodynamic pumping region as is usually the case. As described above, the positive and negatively charged surface regions generate flow in opposite directions and can be used to pump solution into or out of the field free channel, tube, capillary, or hose; a number of channels, tubes, capillaries, or hose in parallel, or a packed bed or porous material held inside a column where the material has a charged surface. In a preferred embodiment, the positive and negative charged regions are filled with a porous material (as discussed above). Filling the channels with a porous material increases the ability of the pump to pump against the hydrodynamic back pressure that it will generate. This resistance to backpressure of the small channels is due to the fact that the volumetric flow rate for hydrodynamic (pressure driven) flow through an open tube is inversely proportional to (the radius)\hat{ }4. The packed bed approximates an array of parallel channels with very small internal diameters. Changing the direction of the hydrodynamic flow in the field free region is achieved by simply changing the polarity of the voltage on the high voltage power supply. It is often detrimental to have the electrode in the channel because it creates bubbles (hydrogen or oxygen) from electrolysis of water, and it can produce other unwanted chemical reactions, such as modification of reactants or sample.

This pump can be used to pump solutions that do not pump well using prior art EOF pumps. These solutions would include non-polar organic solvents that do not generate much EOF, and strong acids or bases or salts where the anions and cations would be pumped at different rates. This EOF pump will be applied to the Edman degradation to pump neat trifluoroacetic acid into and out of the reaction chamber. If the reaction channel was not electric field free, then the hydrogen ions and the counterions would have different rates of migration, and free hydrogen and hydronium ions would reach the reaction chamber first having a detrimental affect on the selective cleavage. The reaction would take place in the reaction field free channel which is when the EOF pump is used.

FIG. 16 shows an embodiment of the present invention as depicted in FIG. 15 further comprising a plurality of hydrodynamic flow restrictors 150. A hydrodynamic flow restrictor 150 prevents contamination of TFA from upstream reagents and solutions during EOF pumping from the TFA channel 144 through the polypeptide concentrating membrane. The flow restrictors minimize the contribution of flow from these intersecting channels. Minimizing flow from the intersecting channels will improve the purity of the TFA in the reaction channel. The flow restrictors 150 can be many small channels in parallel or a macroporous frit-like material. Such macroporous materials will allow for the reagents and large molecules to move through them while increasing the resistance to hydrodynamic flow.

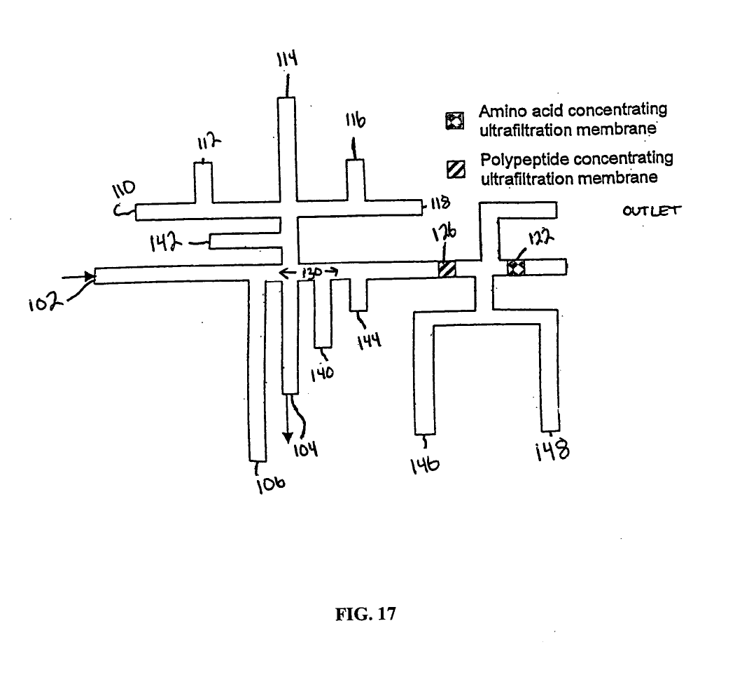

In FIG. 17, the substantially purified polypeptide is confined to the reaction channel 130 by a first ultrafiltration membrane 126. In an embodiment, the substantially purified polypeptide is concentrated at the first ultrafiltration membrane 126. After cleavage of the terminal amino acid of the substantially purified polypeptide, the cleavage product passes through the first ultrafiltration membrane 126 and are concentrated at a second ultrafiltration membrane 122. After the cleavage products are concentrated at the second ultrafiltration membrane 122, the cleavage product is removed from the reaction channel 130 through the exit channel 104. FIG. 17 further shows an embodiment of the invention further comprising an EOF Pump (described above).

In addition to a plurality of reaction channels 130 for cleavage, additional channels may be provided for the present invention. In an embodiment, one or more channels are provided which are cleavage resistant for moving a substantially purified polypeptide directly to a peptide analysis module 67 to obtain a determination of its mass (e.g., for comparison with cleavage products of the substantially purified polypeptide).

In a preferred embodiment, the microfluidic device 55 comprises at least one electrode in communication with one or more of the various channels in the microfluidic device 55 to drive mass transport of polypeptides through the various channels of the microfluidic device 55. In an embodiment of the invention, flow of solution, including polypeptides, is controlled electroosmotically and electrophoretically by control of voltage through the electrode(s). In an embodiment of the invention, providing a silicon oxide layer on a surface of the microfluidic device 55 provides a surface on which conductive electrodes can be formed (e.g., by chemical vapor deposition, photolithography, and the like). The thickness of the layer can be controlled through oxidation temperature and time and the final thickness can be selected to provide the desired degree of electrical isolation. In a preferred embodiment of the invention, a layer of silicon oxide is provided which is thick enough to isolate electrode(s) from the overlying substrate thereby allowing for the selective application of electric potential differences between spatially separated locations in the different channels of the microfluidic device 55, resulting in control of the fluid flow through the different channels. In aspects where the overlying substrate is not glass, one or more electrodes also can be formed on the overlying substrate.

In a preferred embodiment of the invention, the ends of the channels open into reservoirs. In another embodiment of the invention, one or more electrodes can be in electrical communication with a buffer solution provided in a reservoir well at the terminal end of a reaction channel 130.

In another embodiment of the invention, flow through one or more selected channels of the microfluidic device 55 is hydrodynamic and mediated mechanically through valves placed at appropriate channel junctions as is known in the art. See, e.g., as described in U.S. Pat. No. 6,136,212; U.S. Pat. No. 6,008,893, and Smits, Sensors and Actuators A21-A23: 203 (1990). To improve sample handling and ultimately improve detection limits of the system precise control of flow is required. In an embodiment of the invention, flow of reagents in each of the various channels of the microfluidic device 55 is independently controlled. In an embodiment, transport is voltage driven rather than pressure driven. To prevent or reduce feedback or cross talk between channels, electrodes and buffer reservoirs along undesired alternative paths can be used to block feedback by acting as current and electroosmotic flow drains.

To prevent feedback through connected channels, a series of electrodes can be used that act as either a source or drain of electroosmotic flow. If high currents are passed through the drains, problems can arise from Joule heating or rapid consumption of buffer. Buffer consumption is a technical problem that can be solved by appropriate engineering. Buffer out-gassing, which can occur at high levels of Joule heating can be avoided by degassing buffers before use. The maximum voltage used is largely governed by out-gassing of the buffer solutions used in the system. Since current is proportional to voltage, at higher voltages there will be more Joule heating and a greater tendency for out-gassing to occur. With the current scheme of voltage control for sample transport the largest current will flow between the electrodes that are acting as potential and electroosmotic flow sinks, and these are the areas where outgassing will be most likely. However, very high electric field strengths can be used with microfluidic devices 5 as ultrafast separations have been carried out at 53 kV/cm (see, e.g., Figeys et al., 1997, J. Chromatogr., 763: 295-306) and the present invention contemplates the use of high voltage for rapid sample transport, but an electric field strength below 53 kV/cm.

The voltage that each electrode (represented by the black dots) is held at during each stage of the process is shown by the numbers (absolute values are not important but relative values are). In an embodiment, reservoirs are above the microfluidic device 55 and a small hole is drilled in the overlying substrate to connect the channels and the reservoirs. The distances between adjacent electrodes are equivalent so the voltage at each junction can be easily approximated. When the microfluidic device 55 is made from uncoated, fused silica, the direction of electroosmotic flow will always be from high to low voltage with no voltage drop across parallel channels when parallel channels are present.

As shown in FIG. 11, the microfluidic device 55 collects sample bands including substantially purified polypeptides as they elute from an upstream separation module 52. Preferably, a UV detector 73 located near the recipient channel interface 65 will detect the separated sample bands. The rate at which bands reach this UV detector 73 will be used to compute the mobility of the bands and the time at which the electrode voltage should be modulated on the microfluidic apparatus to direct the flow of sample. When the upstream separation module 52 comprises a capillary electrophoresis apparatus, the electrode switching times can be accurately calculated because the phenomena that give rise to transport are the same phenomena that give rise to transport in the microfluidic device.

In an embodiment, fluid can be directed into one or more reservoirs above the microfluidic device 55 if necessary, so only polypeptide bands are sent to the reaction channels 130. In a preferred embodiment, any running buffer from the upstream separation module 52 between sample peaks that does not contain any sample will be eliminated so it does not take up any space within the microfluidic device 55. Elimination of buffer decreases the amount of time the detector 67 will spend analyzing a sample without peptides, thereby increasing the efficiency of the system 51.

In an embodiment, modulation of the potential at the appropriate electrodes in the array will direct the sample band to the proper channel.

The production of bubbles at electrodes can be problematic. In an embodiment, bubbles will be physically separated from the channels when electrodes are held in the buffer reservoirs above the microfluidic device 55 and where the solution in the reservoirs is connected directly with a channel through a hole in the overlying substrate. If the electrodes are integrated directly onto the channels, then buffer additives can be used to suppress bubble formation, as previously reported for an electrospray MS interface (see, e.g., as described in Moini et al., 1999, Analytical Chemistry 71: 1658-1661).

In an embodiment, where sample channels are in the substantially parallel configuration, electroosmotic pressure induced in the reaction channels 130 through intersection with adjacent reaction channels 130 may slowly force sample bands out and decrease the efficiency of the cleavage process. In an embodiment, by providing an on-device imaging detector 73 (discussed further below) in optical communication with one or more of the reaction channels 130, a user can determine whether sample bands including polypeptides and/or their cleavage products are actually stationary. If they are not stationary, many different methods can be used to counter the effects of this pressure. In an embodiment, electroosmotic flow can be actively controlled by controlling the double layer potential as described by Lee et al., 1990, Anal. Chem. 62: 1550-1552; Wu et al., 1992, Anal. Chem. 64: 886-891; Hayes et al., 1993, Anal. Chem. 65: 27-31; Hayes et al., 1993, Anal. Chem. 65: 2010-2013; and Hayes et al., 1992, Anal. Chem. 64: 512-516. Fabrication of a microfabricated apparatus with such control was recently demonstrated by Schasfoort et al., 1999, Science 286: 942-945.

In an embodiment, electroosmotic pressure in channels having a substantially parallel channel configuration also can be stopped by temporarily breaking electrical contact in the channel. Here, bubbles are desirable and are introduced by low pressure into reaction channel(s) 80 to manipulate flow on the microfluidic device 55. In an embodiment, bubbles can be introduced by physically separating sample plugs or by breaking the electrical conductivity in the channel(s). Strategic positioning of a membrane (e.g., such as a hydrophobic membrane made from polypropylene, polyethylene, polyurethane, polymethylpentene, polytetrafluoroethylene, and the like) which is permeable to the bubbles but not the liquid also can be used for bubble removal. In an embodiment, by allowing gas to pass through, but not solution, such a membrane can be used to direct solution flow. Gas permeable membranes are known in the art and are described in U.S. Pat. No. 6,267,926, for example. In a similar manner, a hydrophobic coating strategically located after a channel intersection can be used for fabrication of on-device passive valves. See, e.g., as described in McNeely et al., 1999, SPIE: Bellingham 3877: 210-220.

The microfluidic device 55 can be optimized to provide the minimum number of electrode controls per microfluidic device 55. In an embodiment, this is accomplished by tying some of the electrodes together. In an embodiment, incorporation of voltage dividers into the circuitry which is part of the microfluidic device 55 can be used to always hold a pair of electrodes at the same relative potential, while their absolute potentials are varied. Such schemes would reduce the number of high voltage power supplies and control channels required by a processor in communication with the microfluidic device 55.

### Downstream Separation Apparatus

In a currently preferred embodiment of the present invention, the microfluidic device 55 delivers a cleavage product wherein the cleavage product is a terminal amino acid cleaved from a substantially purified polypeptide traveling through a reaction channel 130 of a microfluidic device 55 to a downstream separation module 64 prior to identification. The downstream separation module can comprise one or more of the separation columns described for an upstream separation apparatus 52 above. In a preferred embodiment of the present invention, high performance liquid chromatography (“HPLC”) is used as a downstream separation apparatus 64. In a preferred embodiment, CE is used as a downstream separation apparatus 64. In a preferred embodiment, CEC is used as a downstream separation apparatus 64. In a preferred embodiment, the retention time of the cleavage product can be compared with known retention times of standard amino acids and the cleavage product can be identified.

In an embodiment, the downstream separation module 64 comprises a capillary electrophoresis apparatus including at least one separation path in communication with the microfluidic device 55 for providing a source of substantially separated cleavage products.

Capillary electrophoresis is a technique that utilizes the electrophoretic nature of molecules and/or the electroosmotic flow of samples in small capillary tubes to separate sample components. Typically a fused silica capillary of 100 μm inner diameter or less is filled with a buffer solution containing an electrolyte. Each end of the capillary is placed in a separate fluidic reservoir containing a buffer electrolyte. A potential voltage is placed in one of the buffer reservoirs and a second potential voltage is placed in the other buffer reservoir. Positively and negatively charged species will migrate in opposite directions through the capillary under the influence of the electric field established by the two potential voltages applied to the buffer reservoirs. The electroosmotic flow and the electrophoretic mobility of each component of a fluid will determine the overall migration for each fluidic component. The fluid flow profile resulting from electroosmotic flow is nearly flat. The observed mobility is the sum of the electroosmotic and electrophoretic mobilities, and the observed velocity is the sum of the electroosmotic and electrophoretic velocities.

To minimize sample loss, CE separations can be used which are capable of sample extraction. Fast CE separations in less then 1 second have been achieved, but these require extremely small injection volumes and short columns. To optimize the peak capacity and speed of a CE separation, it is necessary to determine the minimum column length for a given injection plug length (e.g., such as a sample plug). However, to maximize the peak capacity of an entire sample separation, an injection plug comprising one peak should not be mixed with peak(s) from a previous separation. If the optimized CE requires too long of a column and is too slow to avoid recombining peaks, then multiple CE separations can be run in parallel.

CE can be performed in a capillary or in a channel on the microfluidic device. The dimensions of CE capillary match well with the channels of a microfluidic device 55 in size. CE separations provide a more than adequate amount of sample for both MALDI-MS and ESI-MS/MS-based protein analyses (see, e.g., Feng et al., 2000, Journal of the American Society For Mass Spectrometry 11: 94-99; Koziel, New Orleans, La. 2000; Khandurina et al., 1999, Analytical Chemistry 71: 1815-1819. It should be obvious to those of skill in the art that the exact configuration of the downstream separation module 64 can be varied. In an embodiment, the downstream separation module 64 comprises a separation medium and a capillary between the ends of which an electric field is applied. The transport of a separation medium in the capillary system and the injection of the sample to be tested into the separation medium can be carried out with the aid of pumps and valves but preferably by using electric fields which are suitably applied to various points of the capillary. Analysis time can be optimized by optimizing voltages, with higher voltages between the ends of a separating path generally resulting in an increase in speed. In an embodiment of the invention, voltages of about 10-1000 V/cm are typically used resulting in separation times of about less than a few minutes.

The choice of buffers and reagents in the downstream separation module 64 are preferably optimized to be compatible with a downstream system with which it connects. Similarly, as with the upstream separation module, CE can be combined with a solid-phase extraction (SPE) CE system.

When the repulsion force of the solvated ions exceeds the surface tension of the fluid sample being electrosprayed, a volume of the fluid sample is pulled into the shape of a cone, known as a Taylor cone which extends from the tip of the capillary (see, e.g., Dole et al., 1968, Chem. Phys. 49: 2240 and Yamashita and Fenn, 1984, J. Phys. Chem. 88: 4451). The potential voltage required to initiate an electrospray is dependent on the surface tension of the solution (see, e.g., Smith, 1986, IEEE Trans. Ind Appl. IA-22: 527-535). The physical size of the capillary determines the density of electric field lines necessary to induce electrospray. The process of electrospray ionization at flow rates on the order of nanoliters per minute has been referred to as “nanoelectrospray”. However, the term “electrospray” shall be used to encompass nanospray herein.

Electroosmotic pumping is preferred for rapid delivery of a peptide mixture into a peptide analysis module 67 directly from the downstream separation module 64, especially where the peptide analysis module 67 obtains and analyzes data quickly. In an embodiment, Fast ESI-TOF machines can collect spectra at rates of 4 Hz (Liu et al., 1998, supra). Interfacing with a MALDI apparatus is still straightforward, as automated spotters that connect capillaries and MALDI targets have been developed (see., e.g., Figeys et al., 1998, Electrophoresis 19: 2338-2347).

In some instances, protein analysis time can be extended and detection limits improved by decreasing the flow rate into a peptide analysis module 67 such as an MS apparatus. As discussed above, electrospray is concentration sensitive (Kebarle et al., 1997, supra) and usually the flow rate into the MS is dictated by an upstream separation system, and is therefore not optimized for MS detection. In an embodiment, capillary HPLC-MS is operated at flow rates of about 200 nL/min (see, e.g., Gatlin et al., 1998, Analytical Biochemistry 263: 93-101) and CE-MS is operated at flow rates or about 25 nL/min. To obtain a 20-fold reduction in flow rate, the electrospray must be able to operate at flow rates of 10 nL/min for capillary HPLC-MS and at about 1 nL/min for CE-MS. Such flow rates are low, but stable electrospray has been obtained for flow rates down to 0.5 nL/min (see, e.g., Valaskovic et al., 1995, Analytical Chemistry 67: 3802-3805).

Obtaining very low flow rates (˜0.5 nL/min) at a nanospray source is more dependent on the inside diameter of the capillary than on the inside diameter of the spray tip (Valaskovic, 1995, supra). In an embodiment of the invention, a capillary with a small inside diameter (5-10 μm) is used to interface the downstream separation module to the MS system. In an embodiment, the capillary is interfaced directly with an about 50 μm reaction channel 130 on the microfluidic device 55.

In a further embodiment of the invention, microfluidic device is physically separated from a plurality of nanospray needles which can be aligned for transfer of solution subject to an operator's control (directly or through a processor), using a rotary system similar to one developed for loading microfabricated capillary arrays (see, e.g., Scherer et al., 1999, Electrophoresis 20: 1508-1517). Recently, arrays of electrospray needles have been fabricated on silicon devices (see, e.g., Zubritsky et al., 2000, Anal. Chem. 72: 22A; Licklider et al., Anal. Chem. 72: 367-375).

Each sample band stored in a channel and delivered into the peptide analysis module 67 is not necessarily pure. However, unresolved peaks are common in systems such as capillary LC-MS/MS and all must be analyzed in a very short time. One great advantage of the integrated microfluidic proteomic system 51 according to the present invention is that the nanospray interface allows adequate time to analyze unresolved peptides. Separation and/or focusing by the downstream separation module 64 is a crucial step because sample concentration can be increased by orders of magnitude through sample extraction and concentration. The extraction and concentration capabilities of the integrated system 51 allow a peptide analysis module 67 such as an MS apparatus to analyze a peptide solution of much higher concentration.

### Detectors

Detectors are used for the identification of a cleavage product from a cleavage reaction. In a preferred embodiment of the present invention, an ESI-MS detector is used for the identification of a cleavage product. In a preferred embodiment, a separation combined with a spectroscopic detection is a preferred detection scheme. In an embodiment, as shown in FIG. 11, detectors 73 are placed at various flow points of the system 51 to enable a user to monitor separation efficiency. In an embodiment, one or more spectroscopic detectors 73 can be positioned in communication with various channels, outputs and/or modules of the system 51. Spectroscopic detectors rely on a change in refractive index, ultraviolet and/or visible light absorption, or fluorescence after excitation of a sample (e.g., a solution including proteins) with light of a suitable wavelength.

In another embodiment of the present invention, sample bands including substantially separated proteins (e.g., obtained after passage through the upstream separation module 52) or substantially purified polypeptides (e.g., obtained after passage through the microfluidic device 55 and the downstream separation module 64) are actively sensed by optical detectors which recognize changes in a source light (e.g., such as a ultraviolet source) reacting with the sample bands. In response to such changes the detectors produce one or more electrical signals which are received and processed by processors 68 in electrical communication with the detectors.

In a preferred embodiment of the invention, a detector 73 is provided which detects the fluorescence of the cleaved amino acid which pass through various modules of the integrated proteomic analysis system 51. All PTH amino acids are fluorescent. Most coupling reagents, including PITC, yield products that are both absorbent and fluorescent. In another embodiment, the detector 73 comprises a laser (e.g., a 210-290 nm laser) for excitation of a sample band as it passes within range of detection optics within the system and collects spectra emitted from the polypeptides, partially digested polypeptides, or peptides within the sample band in response to this excitation. The detector 73 can comprise a lens or objectives to further focus light transmitted from the laser or received from polypeptides/peptides.

In an embodiment, the detector 73 transmits signals corresponding to the emission spectra detected to the processor 68 of the integrated system 51 and the processor records the time and place (e.g., module within the system) from which the signals are obtained. Detectors for detecting native fluorescence of polypeptides and peptides and which are able to spectrally differentiate at least tryptophan and tyrosine are known in the art, and described, for example in Timperman et al., 1995, Analytical Chemistry 67(19): 3421-3426, the entirety of which is incorporated by reference herein. As discussed above, the detector 73 can be used to monitor and control sample flow through the integrated proteomic analysis system 51.

In an embodiment, a detector 73 is integrated into the microfluidic device 55 within the integrated proteomic analysis system 51. In an embodiment, a UV or thermal lens detector can be used and integrated into the microfluidic module 55. Recent advancements have been made with both detection systems, and limits of detection for these systems are in the low nanomolar range (see, e.g., Culbertson et al., 1999, Journal of Microcolumn Separations 11: 652-662.) In an embodiment of the invention, a UV detection system with a multi-reflection cell is integrated into a microfluidic device 55 within the integrated proteomic analysis system 51 (see, e.g., as described in Salimi-Moosavi et al., 2000, Electrophoresis 21: 1291-1299). Extremely low yoctomole detection limits have been achieved on-device with a thermal-lens detector (see, e.g., Sato et al., 1999, Analytical Sciences 15: 525-529).

In another embodiment of the invention, as shown in FIG. 11, a detector 73 is placed in optical communication with the separation channel between the upstream separation module 52 and the entrance channel 102 of the microfluidic device 55. The detector 73 detects sample bands delivered by the upstream separation module 52 to the microfluidic device 55 and the processor 68 in response to the signals received from the detector 73 performs a background subtraction which eliminating background electrolyte signal as sample bands are directed to one of the reaction channels 130 in the microfluidic device 55. “Cutting” the sample bands allows the peptide analysis module 67 to spend more of its time on sample analysis and less on analysis of background electrolytes. For low concentration protein samples, a very small fraction of the time (<2%) actually is spent analyzing the sample.

In an embodiment of the present invention, the peptide analysis module 67 comprises its own detector (not shown) which detects spectral information obtained from peptides being analyzed by the system 67. In another embodiment, the protein analysis detector 73 can detect various charged forms of peptide ions as they pass through a peptide analysis module 67, such as an ESI MS/MS system.

As discussed above, in an embodiment, one or more detectors 73 (including the protein analysis detector) are electrically linked to a processor 68. As used herein, the term “linked” comprises either a direct link (e.g., a permanent or intermittent connection via a conducting cable, an infra-red communicating apparatus, or the like) or an indirect link such that data are transferred via an intermediate storage apparatus (e.g. a server or a floppy disk). It will readily be appreciated that the output of the detector should be in a format that can be accepted by the processor 68.

It should be obvious to those of skill in the art that a variety of detectors 73 can be selected according to the types of samples being analyzed. For example, where fluorescently labeled polypeptides/peptides are being analyzed, a laser-induced fluorescence detection system can be used which comprises a 488 nm argon ion laser (available from Uniphase, San Jose Calif.) and focussing optics (see, e.g., as described in Manz et al., 1990, Sens. Actuators, B, B1: 249-255). Detectors 73 additionally can be coupled to cameras, appropriate filter systems, and photomultiplier tubes. The detectors 73 need not be limited to optical detectors, but can comprise any detector used for detection in liquid chromatography and capillary electrophoresis, including electrochemical, refractive index, conductivity, FT-IR, and light scattering detectors, and the like.

### Processors

In a preferred embodiment, a system processor 68 is used to control flow of the cleavage products through the integrated proteomic analysis system 51, e.g., based on data obtained from detectors 73 placed at various positions in the system.

The system processor 68 is in communication with one or more system components (e.g., modules, detectors 73, computer workstations and the like) which in turn may have their own processors or microprocessors. These latter types of processors/microprocessors generally comprise memory and stored programs which are dedicated to a particular function (e.g., detection of fluorescent signals in the case of a detector 73 processor, or obtaining ionization spectra in the case of a peptide analysis module 67 processor, or controlling voltage and current settings of selected channels on a microfluidic device 55 in the case of a power supply connected to one or more microfluidic devices 55 and are generally not directly connectable to the network.

In a preferred embodiment of the invention, the system processor 68 is in communication with at least one user apparatus including a display for displaying a user interface which can be used by a user to interface with the integrated proteomic analysis system 51 (i.e., view data, set or modify system 51 parameters, and/or input data). The at least one user apparatus can be connected to an inputting apparatus such as a keyboard and one or more navigating tools including, but are not limited to, a mouse, light pen, track ball, joystick(s) or other pointing apparatus.

The system processor 68 integrates the function of processors/microprocessors associated with various system components and is able to perform one or more functions: of data interpretation (e.g., interpreting signals from other processors/microprocessors), data production (e.g., performing one or more statistical operations on signals obtained), data storage (e.g., such as creation of a relational database), data analysis (e.g., such as search and data retrieval, and relationship determination), data transmission (e.g., transmission to processors outside the system such as servers and the like or to processors in the system), display (e.g., such as display of images or data in graphical and/or text form), and task signal generation (e.g., transmission of instructions to various system components in response to data obtained from other system components to perform certain tasks).

In an embodiment of the present invention, the system processor 68 is used to control voltage differences in the various modules and channels of the integrated proteomic analysis system 51. In a preferred embodiment of the invention, this control is used to increase the amount of time the peptide analysis module 67 actually spends analyzing sample and obtaining sequence information.

In a preferred embodiment of the invention, the system processor 68 can communicate with one or more sensors (e.g., pH sensors, temperature sensors) and/or detectors 73 in communication with the modules and channels of the integrated proteomic analysis system 51. In another embodiment of the invention, the system processor 68 can modify various system parameters (e.g., reagent flow, voltage) in response to this communication. For example, the output of a detector 73 (e.g., one or more electrical signals) can be processed by the system processor 68 which can perform one or more editing functions. Editing functions comprise, but are not limited to, removing background, representing signals as images, comparing signals and/or images from duplicate or different runs, performing statistical operations (e.g., such as ensemble averaging as described in Wilm, 1996, supra), and the like. Any of these functions can be performed automatically according to operator-determined criteria, or interactively; i.e., upon displaying an image file to a human operator, the operator can modify various editing menus as appropriate. In a preferred embodiment, editing menus, for example, in the form of drop-down menus, are displayed on the interface of a user apparatus connectable to the network and in communication with the system processor 68. Alternatively, or additionally, editing menus can be accessed by selecting one or more icons, radio buttons, and/or hyperlinks displayed on the interface of the user apparatus.

In a preferred embodiment of the invention, the processor 68 is capable of implementing a program for inferring the sequence of a protein from a plurality of cleavage products or unique peptides. Such programs are known in the art and are described in Yates et al., 1991, In Techniques in Protein Chemistry II, by Academic Press, Inc. pp. 477-485; Zhou et al., The 40th ASMS Conference on Mass Spectrometry and Allied Topics, pp. 635-636; and Zhou et al., The 40th ASMS Conference on Mass Spectrometry and Allied Topics, pp. 1396-1397, the entireties of which are incorporated herein by reference.

In an embodiment, the system processor 68 can be used to determine all possible combinations of amino acids that can sum to the measured mass of an unknown peptide being analyzed after adjusting for various factors such as water lost in forming peptide bonds, protonation, other factors that alter the measured mass of amino acids, and experimental considerations that constrain the allowed combinations of amino acids. The system processor 68 can then determine linear permutations of amino acids in the permitted combinations. Theoretical fragmentation spectra are then calculated for each permutation and these are compared with an experimental fragmentation spectrum obtained for an unknown peptide to determine the amino acid sequence of the unknown peptide. Once an experimentally determined amino acid sequence of an isolated protein or polypeptide fragment thereof has been obtained, the system processor 68 can be used to search available protein databases or nucleic acid sequence databases to determine degree of identity between the protein identified by the integrated proteomic analysis system 51 and a sequence in the database Such an analysis may help to characterize the function of the protein. For example, in an embodiment of the invention, conserved domains within a newly identified protein can be used to identify whether the protein is a signaling protein (e.g., the presence of seven hydrophobic transmembrane regions, an extracellular N-terminus, and a cytoplasmic C-terminus would be a hallmark for a G protein coupled receptor or a GPCR).

Where a database contains one or more partial nucleotide sequences that encode at least a portion of the protein identified by the integrated proteomic analysis system 51, such partial nucleotide sequences (or their complement) can serve as probes for cloning a nucleic acid molecule encoding the protein. If no matching nucleotide sequence can be found for the protein identified by the integrated proteomic analysis system 1 within a nucleic acid sequence database, a degenerate set of nucleotide sequences encoding the experimentally determined amino acid sequence can be generated which can be used as hybridization probes to facilitate cloning the gene that encodes the protein. Clones thereby obtained can be used to express the protein.

In an embodiment of the present invention, the system processor 68 is used to generate a proteome map for a cell. In another embodiment of the present invention, the processor 68 also generates proteome maps for the same types of cells in different disease states, for the same types of cells exposed to one or more pathogens or toxins, for the same types of cells during different developmental stages, or is used to compare different types of cells (e.g., from different types of tissues). Maps obtained for cells in a particular disease state can be compared to maps obtained from cells treated with a drug or agent and can be generated for cells at different stages of disease (e.g., for different stages or grades of cancer).

In an embodiment of the present invention, the system processor 68 is used to compare different maps obtained to identify differentially expressed polypeptides in the cells described above. In another embodiment of the invention, the processor 68 displays the results of such an analysis on the display of a user apparatus, displaying such information as polypeptide name (if known), corresponding amino acid sequence and/or gene sequence, and any expression data (e.g., from genomic analyses) or functional data known. In another embodiment, data relating to proteome analysis is stored in a database along with any clinical data available relating to patients from whom cells were obtained.

In an embodiment of the present invention, the display comprises a user interface which displays one or more hyperlinks which a user can select to access various portions of the database. In another embodiment of the invention, the processor 68 comprises or is connectable to an information management system which can link the database with other proteomic databases or genomic databases (e.g., such as protein sequence and nucleotide sequence databases).

In another embodiment of the invention, a proteome map is obtained for a cell including a disrupted cell signaling pathway gene and the map is used to identify other polypeptides differentially expressed in the cell (as compared to a cell which comprises a functional cell signaling pathway gene). Differentially expressed proteins are identified as candidate members of the same signaling pathway.

In an embodiment of the invention, the candidate signaling pathway gene is disrupted in a model system such as a knockout animal (e.g., a mouse) to identify other genes in addition to the candidate signaling pathway gene whose expression is affected by the disruption and which are likely, therefore, to be in the same pathway. Other model systems comprise, but are not limited to, cell(s) or tissue(s) comprising antisense molecules or ribozymes which prevent translation of an mRNA encoding the candidate polypeptide. Methods of generating such model systems are known in the art. By obtaining proteome maps for multiple disrupted candidate signaling polypeptides, the position of the polypeptides in a pathway can be determined (e.g., to identify whether the polypeptides are upstream or downstream of other pathway polypeptides).

### Peptide Analysis Module

The peptide analysis module 67 is preferably some form of mass spectrometer (MS) apparatus including an ionizer, an ion analyzer and a detector. Any ionizer that is capable of producing ionized peptides in the gas phase can be used, such as anionspray mass spectrometer (Bruins et al., 1987, Anal Chem. 59: 2642-2647), an electrospray mass spectrometer (Fenn et al., 1989, Science 246: 64-71), and laser desorption apparatus (including matrix-assisted desorption ionization and surfaced enhanced desorption ionization apparatus). Any appropriate ion analyzer can be used as well, including, but not limited to, quadropole mass filters, ion-traps, magnetic sectors, time-of-flight, and Fourier Transform Ion Cyclotron Resonance (FTICR). In a preferred embodiment of the invention, a tandem MS instrument such as a triple quadropole, ion-trap, quadropole-time-of flight, ion-trap-time of flight, or an FTICR is used to provide ion spectra.

In an embodiment of the invention, molecular ions (e.g., daughter ions) generated by ionization of peptides from a delivery element (e.g., such as an electrospray) are accelerated through an ion analyzer of the peptide analysis module 67 as uncharged molecules and fragments are removed. In an embodiment, the ion analyzer comprises one or more voltage sources (e.g., such as electrodes or electrode gratings) for modulating the movement of ions to a detector component of the peptide analysis module 67. Daughter ions will travel to the detector based on their mass to charge ratio (m/z) (though generally the charge of the ions will be the same). In another embodiment of the invention, the detector produces an electric signal when struck by an ion.

Timing mechanisms which integrate those signals with the scanning voltages of the ion analyzer allow the peptide analysis module 67 to report to the processor 68 when an ion strikes the detector. The processor 68 sorts ions according to their m/z and the detector records the frequency of each event with a particular m/z. Calibration of the peptide analysis module 67 can performed by introducing a standard into the module and adjusting system components until the standard's molecular ion and fragment ions are reported accurately. In an embodiment, the peptide analysis module 67 in conjunction with the processor 68, plots a product ion spectra which corresponds to a plot of relative abundance of ions produced vs. mass to charge ratio. The detected product ions are formed by isolating and fragmenting a parent ion (that is typically the molecular mass of a peptide molecule) in the peptide analysis module 67 (e.g., a mass spectrometer).

Generally, peptides typically fragment at the amide bond between amino acid residues and peaks correspond to particular amino acids or combinations of amino acids. While there may be additional peaks (ions) present in the product ion spectra, many of these other peaks can be predicted and their presence explained by comparison with spectral data of known compounds (e.g., standards). Many different processes can be used to fragment the parent ion to form product ions, including, but not limited to, collision-induced dissociation (CID), electron capture dissociation, and post-source decay.

Analysis of product ion spectra will vary depending upon the particular type of peptide analysis module 67 used.

For high throughput identification of polypeptides, matrix assisted laser-desorption ionization mass spectrometry (MS) peptide finger printing is the method of choice. Although this method is fast, it requires protein database matching and provides the least detailed information. When more detail is needed, ionization tandem mass spectrometry (ESI-MS/MS) is the method of choice (see, e.g., Karger et al., 1993, Anal Chem. 65: 900-906). MS/MS is capable of giving amino acid level sequence information and is required for de novo sequencing and analysis of post-translational modifications. The development of automated database searching programs to directly correlate MS/MS spectra with sequences in protein and nucleic acid databases has greatly increased throughput. New hybrid instruments are being developed to combine MALDI with MS/MS are being developed to combine MALDI with MS/MS to combine speed of analysis with amino acid sequence information. It should be apparent to those of skill in the art that as MS tools evolve new interfaces can be developed to couple microfluidic devices according to the invention with either MALDI or HIS sources.

In an embodiment, the spectra obtained by the peptide analysis module 67 are searched directly against a database for identification of the polypeptide from which the peptide originated. In another embodiment, the peptide analysis module 67 obtains sequence information directly from spectra obtained by the peptide analysis module 67 without the use of a protein or genomic database. This is especially desirable when the protein to be identified is not in a protein database. In an embodiment, rather than performing a search function to compare peptide sequences to a protein database, the processor 68 implements an algorithm for automated data analysis of spectra obtained from the peptide analysis module 67.

In an embodiment, the peptide analysis module 67 facilitates this interaction by isolating daughter ions (MS² ions) obtained from parent ions sprayed into the module (e.g., via an electrospray) and further isolating and fragmenting these to obtain granddaughter ions (MS³ ions) to thereby obtain MS³ spectra. For these types of analyses, ion-trapping instruments such as Fourier transform ion cyclotron resonance mass spectrometers and ion trap mass spectrometers are preferred.

MS³ spectra generally comprise two classes of ions: ions with the same terminus as daughter ions (MS² ions) and ions derived from internal fragments of peptides (some of this latter class comprise C-terminal residues). By identifying peaks that are common to both MS² and MS³ spectra (e.g., contained with an intersection spectrum), a partial sequence of the peptide can be read directly from the intersection spectrum based on the differences in mass of the major remaining ions. Obtaining MS³ spectra of many daughter ions of a peptide will generate many intersection spectra which in turn will generate many partial sequences of different areas of a peptide. Partial sequences can be combined to obtain the complete sequence of the peptide by correlating experimentally acquired spectra with theoretical spectra which are predicted for all of the sequences in a database. A fast Fourier transform can be used to determine the quality of the match. In an embodiment of the invention, detection limits are improved further by ensemble averaging of many spectra (Wilm, 1996, Analytical Chemistry 68: 1-8).

The speed of protein analysis will depend mainly on the voltage used to mobilize the samples, and the number of scans used by the protein analysis system for acquisition of data relating to a sample band. The number of scans can be optimized using methods routine in the art. In an embodiment, for ensemble averaging, the increase in signal-to-noise ratio is equal to the square root of the number of scans averaged, so at larger numbers of scans, there will be diminishing returns. Since increasing the number of scans will also increase analysis time, there will be an optimum number of scans to average. This number will be determined by the efficiency at which the system can load the samples into the electrospray/nanospray capillary and the complexity of the sample.

Higher concentration samples will contain more detectable peaks and will require less averaging. Because lower concentration samples will contain fewer peaks, there will be more time to acquire scans. An optical detection system, such as the one described above, can be used to measure the complexity of a sample before it reaches the MS and this information can be used to determine the optimum scan number.

The peptide analysis module 67 preferably compares the results of multiple runs of sample through the system 51. In an embodiment of the invention, the results of one run are compared to the results of another run utilizing the same protein or peptide sample. In another embodiment, the protein analysis compare multiple runs of sample which have been exposed for various periods of time to proteases within the microfluidic device 55 enabling analysis of undigested, partially digested, and completely digested proteins or polypeptides in the sample.

In another embodiment of the invention, the peptide analysis module 67 identifies post-translational modifications in cellular proteins. Generally, post-translational modifications may be classified into four groups, depending upon the site of chemical modification of the protein. In an embodiment, protein modifications may involve the carboxylic acid group of the carboxyl terminal amino acid residue, the amino group of the amino terminal amino acid residue, the side chain of individual amino acid residues in the polypeptide chain, and/or the peptide bonds in the polypeptide chain. The modifications may be further sub-grouped according to distinct types of chemical modifications, such as phosphorylation, glycosylation, acylation, amidation and carboxylation. Using MS, peptide ions are fragmented into peptide fragment ions which are selected and further fragmented to yield information relating to the nature and site of a modification.

The present invention discloses an electroosmotic flow pump integrated onto a microfluidic device capable of enhancing the ability of the microfluidic device to perform Edman degradation. The microfluidic device's capabilities are enhanced because prior art EOF pumps could not be utilized with various solutions and could not be used over a wide pH range. The EOF pump of the present invention solves these problems by disclosing an EOF pump capable of pumping various solutions at a pH range of about 3 to about 10. As such, the EOF pump of the present invention provides a more efficient and more versatile device as compared with the prior art.

Additionally, the EOF pump of the present invention may be constructed from a set of capillaries and be utilized with a wide range of chemical reactions.

Further, the EOF pump engaged to the microfluidic device may stand alone or may be a piece of the Integrated Microfluidic Proteome Analysis System described above.

Variations, modification, and other implementations of what is described herein will occur to those of skill in the art without departing from the spirit and scope of the invention and the following claims. All references, patents and patent publications cited herein are hereby incorporated by reference in their entireties.

1. An electroosmotic flow pump for use on a microfluidic device comprising:
a first channel comprising a plurality of anionic beads;
a second channel comprising a plurality of cationic beads;
an intersection point where the first channel engages the second channel wherein the first channel and the second channel each narrow in a diameter as each channels approach the intersection point; and
a field free channel engaging the first channel and the second channel at the intersection point.

2. The device of claim 1 wherein the microfluidic device comprises a glass substrate.

3. The device of claim 1 wherein the field free channel comprises a smaller width than the first channel or the second channel.

4. The device of claim 1 wherein the first channel further comprises an active valve.

5. The device of claim 1 wherein the electroosmotic flow pump pumps a reagent having a pH from about 2 to about 12.

6. The device of claim 5 wherein the reagent in used in Edman degradation.

7. The device of claim 5 wherein the reagent is trifluoroacetic acid.

8. The device of claim 1 wherein the anionic beads are chromatography beads.

9. The device of claim 1 wherein the anionic beads are immobilized in the first channel using a weir.

10. The device of claim 1 wherein the anionic beads and the cationic beads are about 5 μm in diameter.

11. The device of claim 1 wherein the anionic beads and the cationic beads are about 0.5 μm in diameter.

12. The device of claim 1 wherein the anionic beads and the cationic beads are of various diameters.

13. The device of claim 1 wherein the first channel and the second channel are approximately linear.

14. The device of claim 1 wherein the field free channel is approximately perpendicular to the first channel and the second channel.

15. The device of claim 1 wherein the anionic beads are silica-based beads.

16. The device of claim 1 wherein the cationic beads comprise a poly(aspartic acid) functional group.

17. The device of claim 1 wherein the anionic beads comprise a polyethyleneimine functional group.

18. The device of claim 1 wherein the anionic beads comprise basic functional groups with a higher pKa.

19. A method of pumping a reagent utilized in Edman degradation comprising:
providing a microfluidic device having a first channel comprising a plurality of anionic beads;
providing a second channel comprising a plurality of cationic beads;
engaging the first channel to the second channel at an intersection point;
engaging a field free channel to the first channel and the second channel at the intersection point, and
pumping the reagent for use in a step of an Edman degradation reaction from the first channel and from the second channel into the field free channel.

20. The method of claim 19 further comprising engaging a first buffer reservoir to the first channel.

21. The method of claim 20 further comprising engaging a second buffer reservoir to the second channel.

22. The method of claim 19 further comprising decreasing the diameter of the first channel and decreasing the diameter of the second channel as the first channel and the second channel approach the intersection point wherein such a decrease in diameters facilitates delivery of the reagent into the field free channel.

23. The method of claim 21 further comprising engaging a third buffer reservoir to the field free channel.

24. The method of claim 19 further comprising placing a weir in at least the first channel to confine the plurality of anionic beads to the first channel.

25. The method of claim 19 further comprising placing a membrane in at least the first channel to confine the plurality of anionic beads to the first channel.

26. The method of claim 19 wherein the microfluidic device comprises glass.

27. The method of claim 19 wherein the reagent is of a pH from about 2 to a pH of about 12.

28. The method of claim 19 wherein the reagent is trifluoroacetic acid.

29. The method of claim 19 wherein the first channel is approximately a same width as the second channel.

30. The method of claim 19 wherein a width of the field free channel is less than a width of the first channel or the second channel.

31. The method of claim 19 wherein the anionic beads and the cationic beads are about 5 μm in diameter.

32. The method of claim 19 wherein the anionic beads and the cationic beads are about 0.5 μm in diameter.

33. The method of claim 19 wherein the anionic beads and the cationic beads are of various diameters.

34. The method of claim 19 wherein the cationic beads comprise a poly(aspartic acid) functional group.

35. The method of claim 19 wherein the anionic beads comprise a polyethyleneimine functional group.

36. A method of utilizing an electroosmotic flow pump over a pH range comprising:
providing a first channel comprising a first set of beads;
providing a second channel comprising a second set of beads;
engaging the first channel to the second channel at an intersection point wherein the first channel and the second channel narrow in diameter as each channel approaches the intersection point;
engaging the first channel and the second channel at the intersection point with a field free channel; and
pumping a reagent electroosmotically through the field free channel.

37. The method of claim 36 wherein the pH range is from about 2 to about 12.

38. The method of claim 36 wherein the first set of beads comprise anionic beads.

39. The method of claim 36 wherein the second set of beads comprise cationic beads.

40. The method of claim 36 wherein the reagent is utilized in a step of Edman degradation.

41. The method of claim 36 wherein the electroosmotic flow pump is integrated onto a microfluidic device.

42. The method of claim 36 wherein the first channel is approximately a same width as the second channel.

43. The method of claim 36 wherein the field free channel comprises a smaller width than the first channel or the second channel.

44. The method of claim 36 wherein the microfluidic device is comprised of glass.

45. The method of claim 36 wherein the electroosmotic flow pump is comprised of a set of capillaries.
